(19) United States
(12) Patent Application Publication
(10) Pub. No.: US 2008/0058067 A1
(43) Pub. Date: Mar. 6, 2008

(54) GAMING MACHINE

(75) Inventors: Kazuo OKADA, Tokyo (JP); Yukinori INAMURA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/735,063

(22) Filed: Apr. 13, 2007

(30) Foreign Application Priority Data
May 11, 2006 (JP) 2006-132884

(51) Int. Cl. A63F 13/00

(52) U.S. Cl. 463/20

(57) ABSTRACT

A gaming environment in which a payout ratio changes is described. The payout ratio may be changed based on information. A symbol table corresponding to the payout ratio may be used in a lottery process in a base game and a bonus game.

### CROSS-REFERENCE TO RELATED APPLICATIONS

This application is based upon and claims a priority from the prior Japanese Patent Application No. 2006-132884 filed on May 11, 2006, the entire contents of which are incorporated herein by reference.

### BACKGROUND

1. Field

One or more aspects of the present invention relate to a gaming machine that controls a game based on predetermined payout ratio and provides a gaming medium to a player.

2. Description of Related Art

Conventionally, in gaming machines such as slot machines and card game machines, a game is started by inputting a gaming medium such as a coin or token, and a game result is displayed based on a random result of an internal lottery conducted in the gaming machines. For example, with respect to slot machines, reels (real or computer generated) with predetermined symbols are stopped and the predetermined symbols are displayed on paylines in the slot machines. With respect to card game machines, a card or cards are drawn and displayed. A payout of a predetermined number of gaming mediums is provided based on the game result. Here, the internal lottery is conducted in accordance with a predetermined payout ratio. With respect to slot machines, a combination of symbols that are stopped on paylines in a base game or free game in the slot machine is randomly determined to comport with the predetermined payout ratio. With respect to card game machines, a number or mark of the drawn card is randomly determined to comport with the predetermined payout ratio. The number of gaming mediums that are paid out is adjusted reflect the predetermined payout ratio.

In the above conventional examples, the gaming machines include plural payout ratios such as 85%, 90%, or 95%. The payout ratio may be set at any of these ratios. Here, a game hall attendant must manually set the payout ratio by individually adjusting the ratio set in the gaming machine. However, many game halls run 24-hours per day, so it is difficult to change the payout ratio while keeping the gaming machines available to players. Also, it is difficult to change the payout ratio in a secure environment. The difference of payout ratios among the game machines may cause wide difference of the number of gaming mediums stored inside the machine and/or paid out from the gaming machines over time. Further, skilled players can determine whether the payout ratio of the game machine is high or low. At result, the player may concentrate his time with the gaming machine having the higher payout ratio. Also, in some countries or regions, the payout ratio is restricted. For example, in the countries or regions having a lower payout limit of 90%, the gaming machine with a payout ratio of 85% is prohibited. At result, the gaming machines have to be tailored for each country or region. This may cause the versatility of any given gaming machine to deteriorate, and may cause the price performance of the gaming machine to deteriorate.

### SUMMARY

In view of the foregoing, one or more aspects of the present invention relate to gaming machine, method of operating a game, computer readable medium having computer-executable instructions or the like that control a game payout in accordance with a payout ratio. Also, in one or more aspects, the payout ratio may be changed based on information. In accordance with some aspects of the present invention, the information may be a predetermined whole payout ratio and/or a variable payout ratio that varies based on, for example, a number of executed games. One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a perspective view showing a slot machine in a first illustrative embodiment in accordance with one or more aspects of the present invention.

FIG. 2 is a view schematically showing symbol row displayed on each of outer surfaces of each reel in accordance with aspects of the present invention.

FIG. 3 is a block diagram showing a control system of the slot machine in the first illustrative embodiment in accordance with one or more aspects of the present invention in accordance with aspects of the present invention.

FIG. 4 is an explanatory view showing a payout ratio and change timing which is set by the slot machine in the first illustrative embodiment in accordance with one or more aspects of the present invention in accordance with aspects of the present invention.

FIG. 5 is a view showing a payout table, which indicates winning combinations and payouts thereof in accordance with aspects of the present invention.

FIG. 6 is a view showing a symbol table A used while the payout ratio is set to 85% in a base game in accordance with aspects of the present invention.

FIG. 7 is a view showing a symbol table B used while the payout ratio is set to 90% in the base game in accordance with aspects of the present invention.

FIG. 8 is a view showing a symbol table C used while the payout ratio is set to 95% in the base game in accordance with aspects of the present invention.

FIG. 9 is a view showing a symbol table D used while the payout ratio is set to 85% in a bonus game in accordance with aspects of the present invention.

FIG. 10 is a view showing a symbol table E used while the payout ratio is set to 90% in the bonus game in accordance with aspects of the present invention.

FIG. 11 is a view showing a symbol table F used while the payout ratio is set to 95% in the bonus game in accordance with aspects of the present invention.

FIG. 12 is an explanatory view showing the symbol table used based on the payout ratio, which is set by the slot machine in the first illustrative embodiment in accordance with one or more aspects of the present invention.

FIG. 13 is an explanatory view showing a bonus game shift lottery table in accordance with aspects of the present invention.

FIG. 14 is a flowchart of a main control process program of the slot machine in the first illustrative embodiment in accordance with one or more aspects of the present invention.

FIG. 15 is a flowchart of a main game process program of the slot machine in the first illustrative embodiment in accordance with one or more aspects of the present invention.

FIG. 16 is a flowchart of a bonus game process program of the slot machine in the first illustrative embodiment in accordance with one or more aspects of the present invention.

FIG. 17 is an explanatory view showing a payout ratio and change timing, which are set by a slot machine in a second illustrative embodiment in accordance with one or more aspects of the present invention.

FIG. 18 is a flowchart of a main game process program of the slot machine in the second illustrative embodiment in accordance with one or more aspects of the present invention.

FIG. 19 is an explanatory view showing a payout ratio and change timing, which are set by a slot machine in a third illustrative embodiment in accordance with one or more aspects of the present invention.

FIG. 20 is a flowchart of a main game process program of the slot machine in the third illustrative embodiment in accordance with one or more aspects of the present invention.

FIG. 21 is an explanatory view showing a payout ratio and change timing, which are set by a slot machine in a fourth illustrative embodiment in accordance with one or more aspects of the present invention.

FIG. 22 is a flowchart of a main game process program of the slot machine in the fourth illustrative embodiment in accordance with one or more aspects of the present invention.

FIG. 23 is an explanatory view showing a payout ratio and change timing, which are set by a slot machine in a fifth illustrative embodiment in accordance with one or more aspects of the present invention.

FIG. 24 is a flowchart of a main game process program of the slot machine in the fifth illustrative embodiment in accordance with one or more aspects of the present invention.

FIG. 25 is an explanatory view showing a payout ratio and change timing, which are set by a slot machine in a sixth illustrative embodiment in accordance with one or more aspects of the present invention.

FIG. 26 is a flowchart of a main game process program of the slot machine in the sixth illustrative embodiment in accordance with one or more aspects of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Some embodiments (a first embodiment to a sixth embodiment, for instance) embodying one or more aspects of the invention as a slot machine will be described below.

### First Embodiment

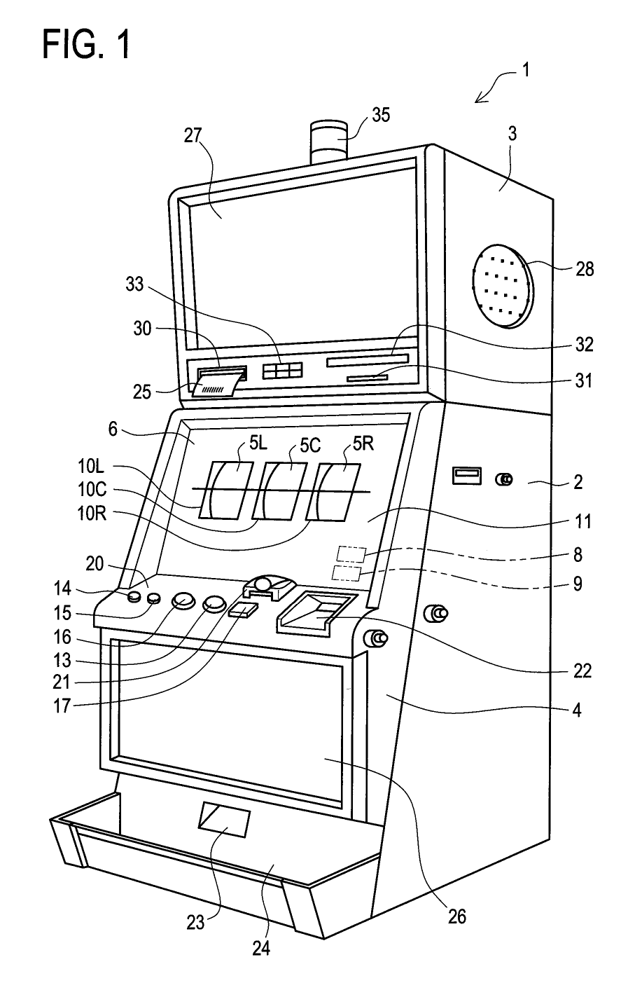

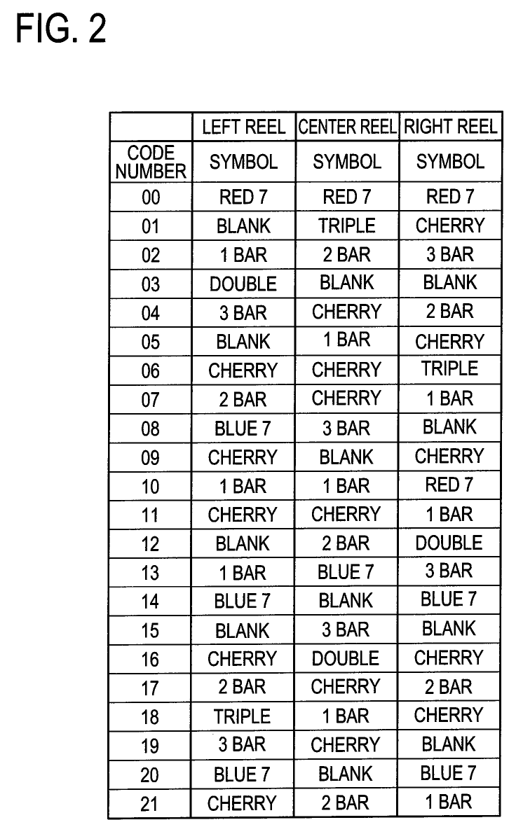

At first, a construction of a slot machine of the first embodiment embodying one or more aspects of the invention will be described with reference to FIG. 1. FIG. 1 is a perspective view showing the slot machine of the first embodiment. The slot machine 1 may include a cabinet 2, a top box 3, and a main door 4. The top box 3 is arranged on the cabinet 2 (for instance, arranged on upper side). The main door 4 is arranged at front of the cabinet 2. Three reels 5L, 5C, and 5R are arranged inside of the cabinet 2. The reels may spin. Some symbols (for example, twenty two symbols) are displayed on outer surface of each of the reels 5L, 5C, and 5R (see FIG. 2). Here, the number of reels is variable (including but not limited to four or five). Here, the reels may be constructed from image data (namely, the virtual reels displayed on the monitor).

A lower image display panel 6 is arranged on the main door 4, namely at the front of the each of the reels 5L, 5C, and 5R. The lower image display panel may be constructed, for instance, from well-known transparent liquid crystal panel. Here, the lower image display may be CRTs, liquid crystal displays, plasma displays, LED displays, OLED displays, and other known display technologies. The symbols displayed on each of the reels 5L, 5C, and 5R are visible through display windows 10L, 10C, and 10R in the base game and the free game. A touch panel 11 is arranged at the front of the lower image display panel 6, and the player can input various instructions by operating the touch panel 11.

A credit count display portion 8 and a payout number display portion 9 are arranged on the lower image display panel 6. The credit count in which the player currently owns may be displayed on the credit count display portion 8. The payout number, which indicates the payout number, which will be provided when a combination of stopped and displayed symbols on payline(s) L, is any of predetermined combinations or will be acquired in the bonus game, may be displayed on the payout number display portion 9.

The display windows 10L, 10C, and 10R are formed at the lower image display panel 6. Each of three symbols displayed on each of outer surfaces of each reel 5L, 5C, and 5R may be visible through each of the display windows 10L, 10C, and 10R. Here, if the reels are image data (namely, the virtual reels displayed on the lower image display), the windows 10L, 10C, and 10R may be displayed on the lower image display panel 6 (namely, the windows 10L, 10c, and 10R may be variably display portions). The payline L may cross three display windows 10L, 10C, 10R (for example, horizontally). The payline(s) L may set the combination of the symbols. If the combination of stopped and displayed symbols is predetermined combination, the payout number will be provided based on the combination and the number of bet credit (referred to herein as the “bet count”).

A control panel 20 is arranged at the image display panel 6 (for example, arranged on lower side). Buttons are arranged at the control panel 20. The buttons are the buttons to input the instructions for gaming session by the player. A coin insertion slot 9 and a bill verifier 22 can be arranged in relation to the image display panel 6 (for example, arranged on lower side). The coin insertion slot 21 may receive the gaming medium into the cabinet 2. A spin button 13, a change button 14, a cash out button 15, a 1-bet button, and a max-bet button 17 are arranged on the control panel 20. The spin button 13 can be used when the instruction for the start for the reels 5L, 5C, and 5R spin is input. Here, a physical lever may be used as substitute for the spin button 13. Also, the physical lever may be used in conjunction with the spin button 13. The change button 14 is used when the exchange is required. The cash out button 15 is the instruction for the payment of the coin (for example, one credit is equal to one coin) or for the print a ticket 25. One or more bar codes may be printed in the ticket 25. The ticket 25 may be called GAMING VOUCHER. The coin may be paid through a coin payout opening 23 to a coin tray 24. Here, other than bar code may be used as substitute for the bar code (for example, QR Code (two-dimensional bar code)). The 1-bet button 16 is used when the instruction for the bet to one credit from the player's credits. The max-bet button 17 is used when the instruction for the bet to available maximum bet count in one game (for example, fifty credits) from the credits which is owned by the player is input.

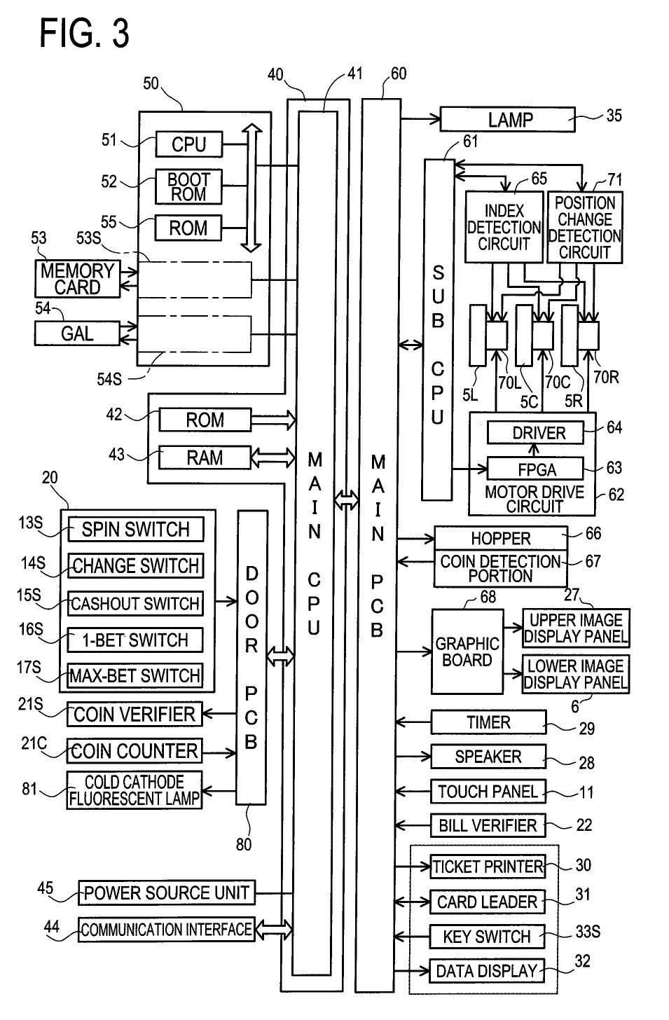

A coin verifier 21S and a coin counter 21C (see FIG. 3) are arranged inside of the coin slot 21. The coin verifier 21S verifies the coin inserted from the coin insertion slot 21, and the fake coins may be discharged through the coin payout opening 23. The coin counter 21C detects qualified coin and counts the number of the coins.

The bill verifier 22 verifies the bill and receives qualified bill into cabinet 2. The bill which is received into cabinet 2 is converted to the coin count, and the credit count corresponding to the converted coin count may be added to the owned credit count of the player. The bill verifier 22 can read a ticket 25 (which will be described later). A panel 26 is arranged on the main door 4 (for example, arranged on lower side, namely arranged below the control panel 20). Characters of the slot machine 1 may be displayed on the panel 26.

In the slot machine of the first embodiment, the gaming medium may be coin, bill, or electronic value (credit). Here, the gaming medium may be other things as well (including but not limited to medal, token, electronic money, or ticket).

An upper image display panel 27 is arranged with the slot machine 1 (for example, arranged in front of the top box 3). The upper image display panel 27 may include the display device (for example, LCD panel). Gaming information such as JACKPOT and the instructions for the game may be displayed on the upper image display panel 27. A speaker is arranged with respect to the slot machine 1 (for example, arranged side of the top box 3).

A ticket printer 30, a card reader 31, a data display 32, and a keypad 33 are arranged at the upper image display panel 27 (for example, arranged on lower side). The ticket printer 30 prints the ticket with the bar code in which the data (such as credit count, data, or ID number of the gaming machine) is coded. The printed ticket is the ticket 25. When the ticket 25 is scanned by other gaming machines, the player will be able to play the other gaming machines or be able to go through some procedure in some place. The card reader 31 reads from the storage medium (for example, smart card) and writes the storage medium (for example, smart card). The player owns the storage medium, and the gaming record of the player is stored in the storage medium. The data (which is read by the card reader 31 or input data which is input by the player via the keypad 33) may be displayed on the data display 32. The keypad 33 may be used when the player input the instruction or the data related to the print the ticket (for example). A lamp 35 is arranged at the top box 3 (for example, arranged on top). The lamp 35 may turn on with predetermined pattern when the player wants call the clerk of the game hall when the slot machine 1 has errors (for example).

The symbols displayed on each of outer surface of the reels 5L, 5C, and 5R will be described with reference to FIG. 2. The symbols may be variably displayed while being scrolled in the game in one or more aspect of the invention. The symbols are visible through the display windows 10L, 10C, and 10R of the lower image display panel 6. FIG. 2 is a view schematically showing the symbols displayed on the each of outer surfaces of each reel 5L, 5C, and 5R.

Some symbols (for example, twenty-two symbols) are displayed on the left reel 5L, the center reel 5C, and the right reel 5R. Here, the number of symbols is variable. The symbols may include “TRIPLE”, “DOUBLE”, “RED7”, “BLUE7”, “3BAR”, “2BAR”, “1BAR”, and “CHERRY”. Here, the kinds of symbols are variable. The symbols and “BLANK” may be displayed each reel 5L, 5C, and 5R as shown in FIG. 2.

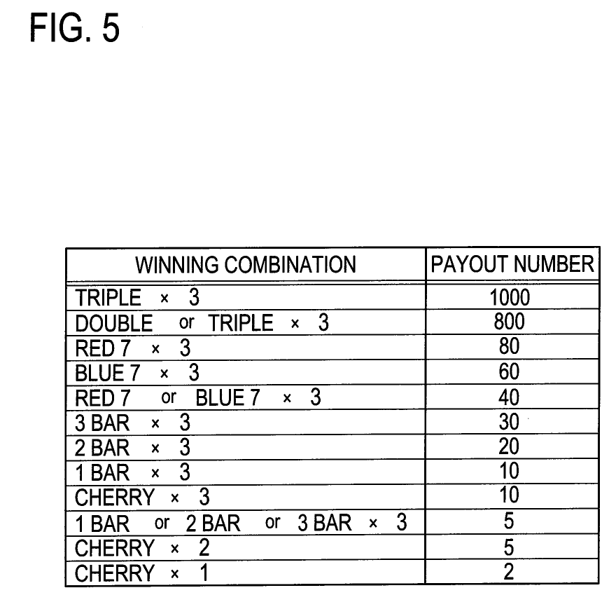

When three “RED7”s, “BLUE7”s, “3BAR”s, “2BAR”s, “1BAR”s, or “CHERRY” are stopped and displayed on the payline, predetermined payout number may be provided (see FIG. 5). When one or two “CHERRY”s are stopped and displayed on the payline, predetermined payout number may be provided based on the number thereof (see FIG. 5).

When the bet count is determined based on the operation of the 1-bet button 16 or max-bet button 17, and then the spin button 13 is input, the reels 5L, 5C, and 5R will start to spin. Accordingly, the symbols may be variably displayed in the display windows 10L, 10C, and 10R (for example, scrolled from top to bottom). After a predetermined time, the reels 5L, 5C, and 5R will end spinning. Accordingly, the symbols will be shown in the display windows 10L, 10C, and 10R. Here, winning combinations of the symbols are set beforehand (see FIG. 5). If the symbols which form the winning combination stop on the payline, the payout number corresponding to the winning combination thereof will be provided to the player.

“TRIPLE” and “DOUBLE” may be the wild card for other symbols (“RED7”, “BLUE7”, “3BAR”, “2BAR”, “1BAR”, and “CHERRY”). If the winning combination is provided with a “TRIPLE” wildcard, the payout number may be triple the standard payout. If the winning combination is realized with “DOUBLE”, the payout number may be doubled. If the winning combination is realized with at least two any of “TRIPLE” or “DOUBLE”, the payout number may become four, six, or nine times based on the combination.

In the slot machine 1 of the first embodiment, the internal lottery for the shift to bonus game may be conducted every game other than the lottery for the stop symbols. If the lottery for the shift to bonus game is won, the bonus game (for example, mystery game) may be executed after the reels 5L, 5C, and 5R stop (namely, the base game is ended) regardless of the combination of the symbols stopped on the payline. The bonus game executed in the slot machine 1 of the first embodiment may be the free game. The free game will be executed without the consuming credit.

A control system of the first embodiment of the slot machine 1 will be described with reference to FIG. 3. FIG. 3 is block diagram schematically showing the control system of the slot machine 1 of the first example of the slot machine 1.

The control system of the slot machine 1 may be constructed from a mother board 40 and a gaming board 50 as shown in FIG. 3. The gaming board 50 may be constructed from a CPU 51, a ROM 55, a boot ROM 52, a card slot 53S, and an IC socket 54S. The CPU 51, the ROM 55, the boot ROM 52 are interconnected via internal bus. A card slot 53S is adapted to receive the memory card 53. An IC socket 54S is adapted to receive a GAL (Generic Array Logic) 54. Here, PLD (Programmable Logic Device) which is other than the GAL 54 may be substituted for the GAL 54.

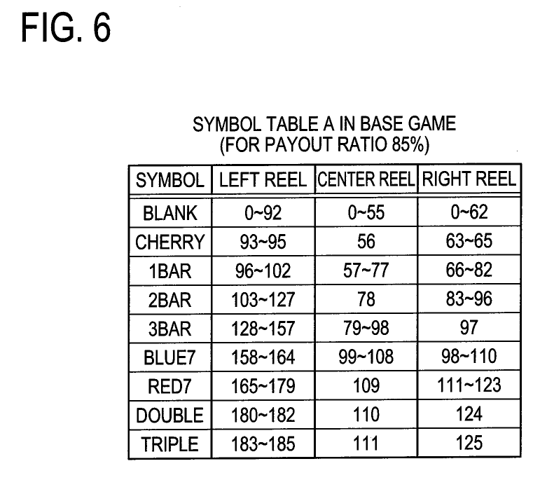

The memory card 53 may be constructed from non-volatile memory. A game program and a game system program (hereinafter, “the game program and the like”) is stored therein. The game program stored in the memory card 53 may include a lottery program. The lottery program is used to determine the symbols (code numbers corresponding to symbols) of each reel 5L, 5C, and 5R to be displayed on the payline. The symbol tables of the base game and the bonus game are stored in the memory card 53 (see FIGS. 6 to 11). Each of the symbol tables correspond to any of payout ratios (for example, 85%, 90%, or 95% in the first embodiment) which can be changed based on a predetermined timing in the slot machine 1. Here, the payout ratio may be defined as ratio by credit value of output to bet (or input), namely the payout ratio may be defined as (output value)/(bet value). Also, the definition of the payout ratio is variable. The symbol tables indicate the relation between each symbol of each three reels 5L, 5C, and 5R and one or more random number values which lie in predetermined range (for example, “0” to “185” for reel 5L, “0” to “111” for reel 5C, and “0” to “125” for reel 5R). Each of the symbols corresponds to one or more random number values. The random number values are sampled in the lottery process, and the symbol corresponding thereto will be stopped and displayed. The symbol lottery tables will be described later.

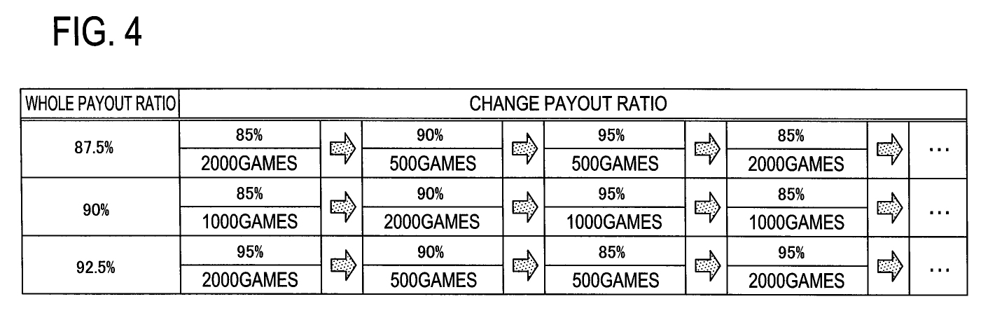

The payout ratio, which is set in the slot machine 1, will be set based on a payout ratio setting data output from the GAL (which, for instance, may be inserted by the clerk of the game hall). The lottery may be conducted based on the symbol table corresponding to input payout ratio. The payout ratio in the slot machine 1 of the first embodiment will be described with reference to FIG. 4. A whole payout ratio in the slot machine 1 in the first embodiment can be set to any value including 87.5%, 90%, and 92.5% based on the payout ratio set data output from the GAL 54. The whole payout ratio may be an expected value of the payout ratio. For instance, the whole payout ratio may be average payout ratio of the slot machine 1 over a time period and/or a predetermined number of executed games. The time period may be an hour, a day, a number of days, a number of weeks, and/or a number of years. In short, the whole payout ratio may be set for any length of time. The predetermined number of executed games is variable. The whole payout ratio may be set by the clerk of the game hall so as to meet the regulation of the countries or areas in which the slot machine 1 may be placed.

In aspect of the invention, the main CPU 41 sequentially changes the payout ratio based on the whole payout ratio, which is set, and the number of executed games. For example, if the whole payout number is set to 87.5%, at first, “2000” games may be executed with 85% payout ratio. After that, the payout ratio will be changed from 85% to 90%, and “500” games may be executed with 90% payout ratio. After that, the payout ratio will be changed from 90% to 95%, and “500” games may be executed with 95% payout ratio. After that, the payout ratio may be changed again from 95% to 85%. Accordingly, the whole payout ratio may be 87.5% through whole games even though the payout ratio changes in the range of 85% to 95%.

For example, if the whole payout ratio is set to 90%, at first, 1000 games may be executed with the 85% payout ratio. After that, the payout ratio can be changed from 85% to 90%, and then 2000 games may be executed with the 90% payout ratio. After that, the payout ratio can then be changed from 90% to 95%, and 1000 games may be executed with the 90% payout ratio. After that, the payout ratio may be changed again from 95% to 85%. Accordingly, the whole payout ratio may be 90% for the collection of games played during a longer time interval even though the payout ratio changes in the range of 85% to 95% over a shorter time interval.

For example, if the whole payout number is set to 92.5%, at first, 2000 games may be executed with the 95% payout ratio. After that, the payout ratio will be changed from 95% to 90%, and 500 games may be executed with the 90% payout ratio. After that, the payout ratio will be changed from 90% to 85%, and 500 games may be executed with the 90% payout ratio. After that, the payout ratio may be changed again from 85% to 95%. Above process cycle may be executed. Accordingly, the whole payout ratio may be 92.5% through whole games even though the payout ratio changes in the range of 85% to 95%.

Here, the relation between the payout ratio and the number of executed games therewith may or may not be determined with the use of the whole payout ratio and/or the payout ratios. For example, the number of executed game with the 95% payout ratio may or may not be determined based on the whole payout ratio, the 95% payout ratio, and another payout ratio (85% and/or 90%). Further, the whole payout ratio may be controlled based on the numbers of executed games correspond to each of the payout ratios. For example, the higher whole payout is set, the longer the 95% payout ratio may be used. Here, the kind of the payout ratio is variable and the number of the kinds is variable. For example, two payout ratios (including but not limited to 85% and 95%) may be used in the slot machine 1. In this case, the number of executed games with the 85% payout ratio and the number of executed games with the 95% payout ratio may be determined based on the 85% payout ratio, the 95% payout ratio, and the whole payout ratio. For example, the whole payout is set for 90% while 2000 games are executed, the number of executed games with the 85% payout ratio will be 1000, and the number of executed games with the 95% payout ratio will be 1000.

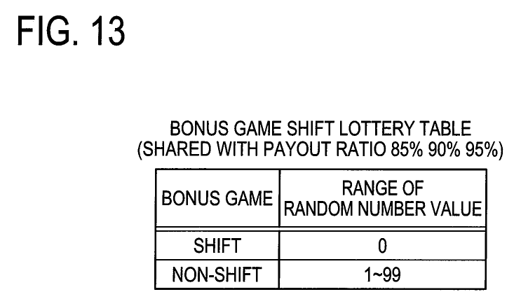

A bonus game shift lottery table (see FIG. 13), which is used to determine whether or not the bonus game will be shifted after the base game, can be stored in the memory card 53. The bonus game shift lottery table indicates the relation between the approval information for the shift to the bonus game and one or more random number values which lies in predetermined range (for example, “0” to “99”).

The card slot 53S may be constructed so that the memory card 53 is detachable, and connected to the mother board 40 via bus (for example, IDE bus). The kinds of the game and the contents of the game executed in the slot machine 1 can be changed in a case where the game program and the like stored in the memory card 53. Also, the kinds of games and the contents of the games executed in the slot machine 1 can be changed in a case where the memory card 53 is exchanged to another memory card in which another game program or the like is stored therein. The game program may include the program related to the gaming session, the image data and sound data as output during the gaming session, and notification data such as the image data or sound data.

The GAL 54 can be one of the PLD, which may contains a fixed OR array. The GAL 54 has plural input ports and output ports. If predetermined data is input to the input port(s), the data corresponding thereto will output to the output port(s). The output data is the payout ratio setting data.

The IC socket 54S is constructed so that the GAL 54 is detachable, and connected to the mother board 40 via a bus (for example, PCI bus). The payout ratio setting data can be changed in a case where the GAL 54 is re-written or is exchanged.

The CPU 51, the ROM 55, and the ROM 52 are connected to the mother board 40 via the PCI bus. The CPU 51, the ROM 55, and the boot ROM 52 are interconnected via internal bus. The PCI bus transmits the signal between the mother board 40 and the gaming board 50. The mother board 40 supplies the electric power to the gaming board 50. The country ID and the verification program are stored in the ROM 55. The preliminary verification program and the boot code may be stored in the boot ROM 52. The CPU 51 may boot the preliminary verification program with the use of the boot code.

The verification read program is used to verify the game program and the like. The verification program is executed to check whether or not falsification of data has been done. The verification program checks for the falsification of the game program and the like. The game program and the like will be the object of the verification read process. A preliminary verification program may or may not be used to verify the verification program. The preliminary verification program is written along the procedure for the check of falsification of the verification program. The verification program can be the object of the verification process.

The mother board 40 will be described. The mother board 40 may be constructed from general mother board (printed circuit board which mounts basic components), and may include a main CPU 41, a ROM 42, a RAM 43, and a communication interface 44.

The ROM 42 may be constructed from a memory device such as the flash memory (for example). The preliminary data such as BIOS program and the payout table in the base game (see FIG. 5) may be stored in the ROM 42. BIOS program can be executed by the main CPU 41. If the BIOS is executed by the main CPU 41, the initial process for predetermined peripheral devices, and the read process for the game program and the like stored in the memory card 53 will be started via the gaming board 50.

The data and the program, which are used when the main CPU 41 runs, are stored in the RAM 43. The verification program (which will be read via the gaming board 50), various programs (such as the game program and the like), the number of the player's credits, and the number of executed games may be stored in the RAM 43.

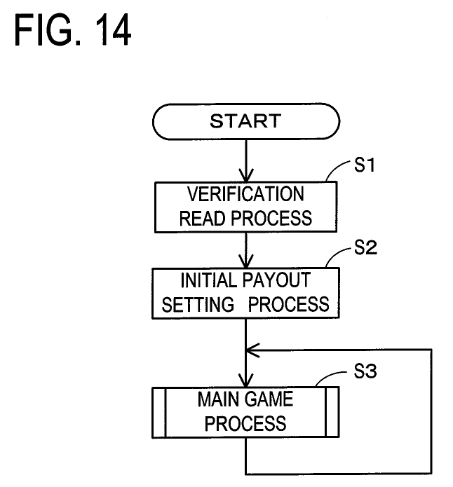

The communication interface 44 can be a communication device communicating to the server located in the game hall via a communication line or other communication pathway. The slot machine 1 may communicate bet information in the main game process (which will be described later, see S3 of FIG. 14) and/or the random result of a base winning combination lottery process with the server via the communication interface.

A main PCB (Printed Circuit Board) 60 and a door PCB 80 (which will be described later) are connected to the mother board 40 respectively via USB (for example). A power source unit 45 is connected to the mother board 40. If the power source unit 45 supplies the electric power to the mother board 40, the main CPU 41 on the mother board 40 will be booted up. When the electric power is supplied to the gaming board 50, the CPU 51 will be booted up.

Some devices, which generate the input signal to the main CPU 41, are connected to the main PCB 60 and the door PCB 80. Some devices, which are control by the control signal from the main CPU 41, are connected to the main PCB 60 and the door PCB 80. The main CPU 41 executes the game program and the like stored in the RAM 43 based on the input signal which is input thereto. The CPU 41 stores the calculation result to the RAM 43 and controls some devices by executing predetermined calculation process.

The lamp 35, a sub CPU 61, a hopper 66, a coin detection portion 67, a graphic board 68, the speaker 28, a timer 29, a touch panel 11, the bill verifier 22, the ticket printer 30, the card reader 31, a key switch 33, and data display 32 may be connected directly or indirectly to the main PCB 60.

The timer 29 measures the time, and includes a calendar function. Time information of the timer 29 is transmitted to the main CPU 41. The main CPU 41 can detect the playing time since the slot machine 1 started to be operated, in addition to the current date, day, and time.

The touch panel 11 may be arranged in front of the lower image display panel 6. The touch panel 11 can recognize the place where the player touches the touch panel 11 based on the coordinate information of the portion touched by the player. Also, the touch panel 11 can recognize the direction where the player touches and moves based on the coordinate information of the portion touched by the player.

The sub CPU 61 controls the spin and the stop for each of the reels 5L, 5C, and 5R. FPGA (Field Programmable Gate Array) 63 and a motor drive circuit 62 are connected to the sub CPU 61. Here, PLD (Programmable Logic Device), which is other than the FPGA 63, may be substituted form the FPGA 63. The motor drive may include driver 64. The FPGA may be a programmable circuit such as a LSI. The FPGA functions as the control circuit for stepping motors 70L, 70C, and 70R. The driver 64 functions as amplifier circuit for input pulse, which will be input to the stepping motors 70L, 70C, and 70R. The stepping motors 70L, 70C, and 70R are connected to the motor drive circuit 62. The stepping motors may be such as but not limited to a half step drive. The reels 5L, 5C, and 5R are spun by the stepping motors 70L, 70C, and 70R.

An index detection circuit 65 and a position change detection circuit 71 are connected to the sub CPU 61. The index detection circuit 65 detects the positions (for example, base point) of the reels 5L, 5C, and 5R, and detects the current position of the reels 5L, 5C, and 5R. The slot machine 1 may change the stop position of the reels 5L, 5C, or 5R so that the combination of the stopped symbols on the payline is won. The position shift detection circuit 71 detects the position change in the above case.

The hopper 66 is arranged inside of the cabinet 2. The hopper 66 pays a payout with coins through the coin payout opening 23 to the coin tray 24 based on the control signal from the main CPU 41. The coin detection portion 67 is arranged inside of the coin payout opening 23. If the coin detection detects that predetermined coins are paid through the coin payout opening 23, the coin detection portion will output the signal to the main CPU 41.

The graphic board 68 controls the display image on the upper image display panel 27 and the lower image display panel 6 based on the control signal from the main CPU 41. The player's credit count, stored in the RAM 43, may be displayed of the credit count display portion 8. The payout number may be displayed on the payout count display portions 9. The graphic board 68 may include VDP (Video Display Processor) and a video RAM. The image data generated by the VDP is temporarily stored in the video RAM. The VDP generates the image data based on the control signal from the main CPU 41. The data used when the image data is generated by the VDP may be included in the game program.

The bill verifier 22 verifies the bill or the ticket 25. The bill verifier 22 receives the qualified bill or the ticket 25 into the cabinet 2. When qualified bill is inserted, the bill verifier 22 will output the signal to the main CPU 41 based on the value thereof. When qualified ticket 25 is inserted, the bill verifier 22 will output to the main CPU 41 based on the number of coins printed thereon.

The ticket printer 30 prints the ticket with the bar code in which the data such as credit count stored in the RAM 43 based on the control signal from the main CPU 41. The printed ticket is the ticket 25. The card reader 31 reads from the storage medium (for example, smart card) and transmits the data, which is received by the main CPU 41. The card reader writes the storage medium (for example, smart card) based on the control signal from the main CPU 41. A keypad 33 is arranged on the key switch 33S. If the keypad 33 is operated by the player, the predetermined input signal will be output to the main CPU 41. The data read by the card reader 31 or the data input by the player via the keypad 33 may be displayed on the data display 32 based on the control signal from the main CPU 41.

A control panel 22, the coin verifier 21S, and the coin counter 21C are directly or indirectly connected to the door PCB 80. Here, a cold cathode fluorescent lamp 81 may be connected to the door PCB 80. A spin switch 13S, a change switch 14S, a cash-out switch 15S, a 1-bet switch 16S, and a max-bet switch 17S are arranged on the control panel 20. The spin switch 13S is associated with the spin button 13. The change switch 14S is associated with the change button 14. The cash-out switch 15S is associated with the cash-out button 15. The 1-bet switch 16S is associated with the 1-bet button 16. The max-bet switch 17S is associated with the max-bet button 17. Each of switches may output the input signal to the main CPU 41 when the button corresponding thereof is operated by the player.

The coin counter 21C is arranged inside of the coin insertion slot 21. The coin counter 21C verifies the coin inserted from the coin insertion slot 21 by the player. Any fake coins may be discharged through the coin payout opening 23. If a qualified coin is detected, the coin counter 21C will output the signal to the main CPU 41.

The coin verifier 21S is controlled based on the control signal from the main CPU 41. The coin verifier 21S sorts the qualified coins into a cash box (not shown) or the hopper 66. The cash box is arranged inside of the slot machine 1. Here, the lower image display panel 6 is a LED. A cold cathode fluorescent lamp 81 may be arranged back side of the lower image display panel 6 and the upper image display panel 27. Here, a cold cathode fluorescent lamp 81 functions as a back light and turns on based on the control signal from the main CPU 41.

The winning combination and payout thereof, in the base game and the bonus game using the reels 5L, 5C, and 5R in the slot machine 1 of the first embodiment, will be described with reference to FIG. 5. FIG. 5 shows the payout table which indicates the winning combination, the probability thereof, and the payout number thereof, in the game using the reels 5L, 5C, and 5R. FIG. 5 indicates the payout number in the case where the bet count is “1”. If the bet count is “1”, the payout number shown in FIG. 5 will be added to the credit count. If the bet count are more than “1”, the payout number shown in FIG. 5 will be multiplied by the bet count, and multiplied number will be added to the credit count.

For example, if three “TRIPLE” symbols are stopped and displayed on the payline L, the payout number 1000 will be provided. If three symbols stopped and displayed on the payline L include only “TRIPLE” and “DOUBLE” (namely, any mixed of “TRIPLE” and “DOUBLE”, for example, “TRIPLE-TRIPLE-DOUBLE”), the payout number 800 will be provided. If three “RED7” symbols are stopped and displayed on the payline L, the payout number 80 will be provided. Similarly, as shown in FIG. 5, each of the combinations of the symbols corresponds to the payout. If the combination other than shown in FIG. 5 is stopped and displayed, no credit will be provided (namely, the combination is blank.).

A symbol lottery table will be described with reference to FIGS. 6 to 11. The symbol lottery table is used when the symbols to be stopped on the payline are determined in the base game and the bonus game in first embodiment of the slot machine 1. The symbol lottery table indicates the relation between each of the symbols of the each of the reels 5L, 5C, and 5R and the predetermined range of the random number values (for example, “0” to “185” for the reel 5L, “0” to “111” for the reel 5C, and “0” to “125” for the reel 5R). The main CPU 41 determines the symbols to be stopped and displayed on the payline based on the sampled random number values and the symbol lottery table.

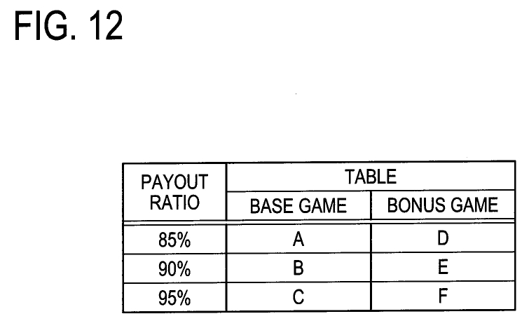

The symbol lottery table used in the slot machine 1 of the first embodiment may include six symbol tables A to F. Here, the number of the symbol tables is variable. Each of the symbol tables will be used based on the set payout ratio (any of 85%, 90%, or 95%, see FIG. 4, for example) and the kind of game (see FIG. 12). The payout ratio is set based on the whole payout ratio and the number of executed games.

FIG. 6 shows the symbol table A. When the payout ratio is set to 85% and current game is the base game, the symbol table A may be used. For example, if the random number value sampled for left reel 5L lies in from “0” to “92”, symbol “BLANK” may be stopped on the payline. If the random number value from “93” to “95”, symbol “CHERRY” may be stopped on the payline. Similarly, “1BAR”, “2BAR”, “3BAR”, “BLUE7”, “RED7”, “DOUBLE”, and “TRIPLE” are respectively correspond to the range of the random number value. Similarly, each of the symbols of the center reel 5C and the right reel 5R correspond to the range of the random number value. Here, the expected value of the payout ratio in the base game with symbol table A is 85.192%.

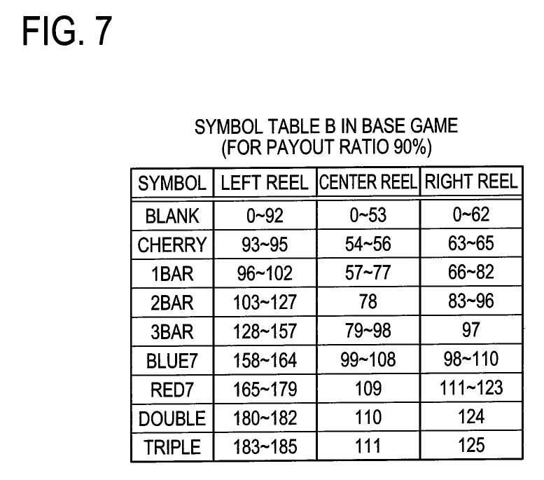

FIG. 7 shows the symbol lottery table B. When the payout ratio is set to 90% and current game is the base game, the symbol lottery table B may be used. Each of the symbols of the left reel 5L, the center reel 5C, and the right reel 5R corresponds to the range of the random number value in the symbol lottery table B as shown in FIG. 7. The expected value of the payout ratio in the base game with symbol lottery table B is 89.773%.

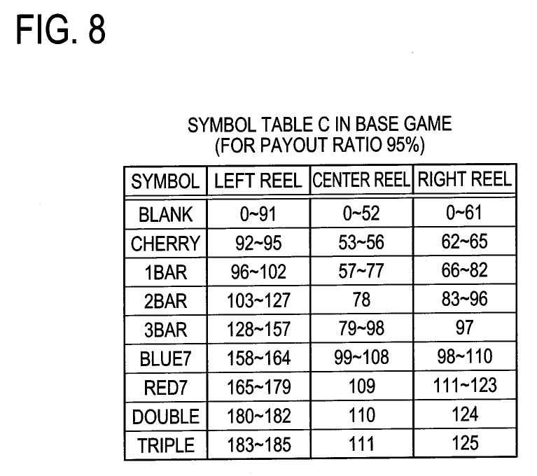

FIG. 8 shows the symbol table C. When the payout ratio is set to 95% and current game is the base game, the symbol lottery table C may be used. Each of the symbols of the left reel 5L, the center reel 5C, and the right reel 5R corresponds to the range of the random number value in the symbol lottery table C as shown in FIG. 8. The expected value of the payout ratio in the base game with symbol lottery table C is 95.434%.

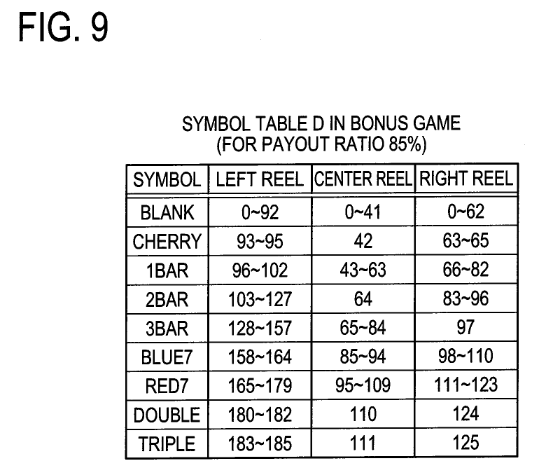

FIG. 9 shows the symbol table D. When the payout ratio is set to 85% and current game is the bonus game, the symbol lottery table D may be used. Each of the symbols of the left reel 5L, the center reel 5C, and the right reel 5R corresponds to the range of the random number value in the symbol lottery table D as shown in FIG. 9. The expected value of the payout ratio in the base game with symbol lottery table D is 121.184%.

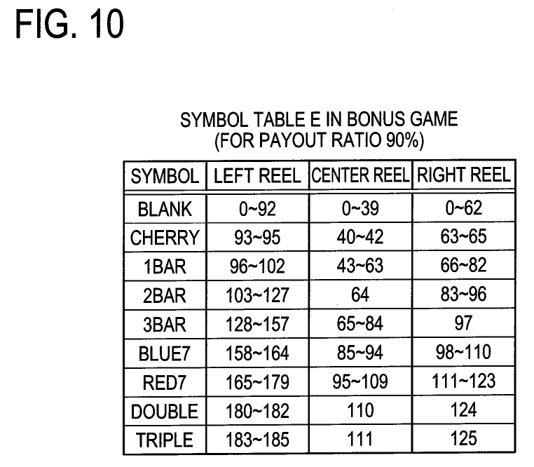

FIG. 10 shows the symbol table E. When the payout ratio is set to 90% and current game is the bonus game, the symbol lottery table E may be used. Each of the symbols of the left reel 5L, the center reel 5C, and the right reel 5R corresponds to the range of the random number value in the symbol lottery table E as shown in FIG. 10. The expected value of the payout ratio in the base game with symbol lottery table E is 125.764%.

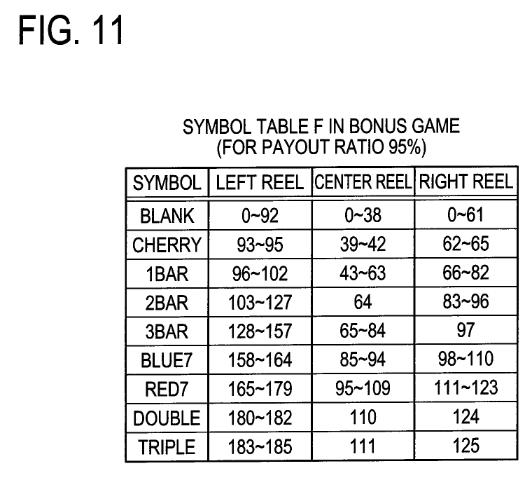

FIG. 11 shows the symbol table F. When the payout ratio is set to 95% and current game is the bonus game, the symbol lottery table F may be used. Each of the symbols of the left reel 5L, the center reel 5C, and the right reel 5R corresponds to the range of the random number value in the symbol lottery table F as shown in FIG. 11. The expected value of the payout ratio in the base game with symbol lottery table F is 131.426%.

The bonus game shift lottery table in the slot machine 1 of the first embodiment will be described. It is determined whether or not the procedure will be shifted to the bonus game based on the bonus game shift lottery table. FIG. 13 shows the bonus game shift lottery table. The bonus game shift lottery table indicates the relation between the approval information for the shift to the bonus game and one or more random number values which lies in predetermined range (for example, “0” to “99”). When the spin button is pressed by the player, the random number value will be sampled in range of “0” to “99”. The CPU 41 determined whether or not the procedure will be shifted to the bonus game after the base game is finished based on the sampled random number value. If the random number value is “0”, the bonus game will be won. Accordingly, the procedure will be shifted to the bonus game after the base game is finished. If the random number value lies from “1” to “99”, the procedure will end without the bonus game. Here, the bonus game shift lottery table used in the first embodiment of the slot machine 1 is the same regardless of the payout ratio (which is set by the slot machine 1), however, plural bonus game shift lottery tables, which correspond to the payout, may be used.

A main control program, which is executed in the slot machine 1 of the first embodiment, will be described in detail with reference to the drawing. FIG. 14 is a flowchart of the main control program. Concerning the slot machine 1, the memory card 53 is connected to the card slot 53S of the gaming board 50, and the GAL 54 is connected to the IC socket 54S.

When the power switch of the power source unit 45 is ON, the mother board 40 and the gaming board 50 are booted-up respectively, and the verification read process (S1) is executed. In the verification read process, the mother board 40 and the gaming board 50 execute separate processes in parallel. In the gaming board 50, the CPU 51 reads the preliminary verification program from the boot ROM 52, and verifies that the verification program is not falsified before the verification program is taken to the mother board 40. In the mother board 40, the main CPU 41 executes BIOS stored in the ROM 42, and checks and initializes various peripheral devices. Here, BIOS may be compressed, then, BIOS is decompressed. BIOS may be copied to the RAM 43.

The CPU 41 reads the verification program stored in the ROM 55, and verifies that game program and the like is not falsified. Here, the game program and the like is stored in the memory card 53 which is inserted to the card slot 53S. After the verification process is ended, the main CPU 41 writes program to the RAM 43, and acquires payout data and country ID. After the process mentioned above is finished, the main CPU 41 finishes the verification read process.

In S2, the main CPU 41 sets the whole payout ratio to any of 87.5%, 90%, or 92.5% based on the payout ratio setting data. For example, if the whole payout ratio is set to 87.5%, initial payout ratio will be set to 85%. If the whole payout ratio is set to 90%, initial payout ratio will be set to 95%. If the whole payout ratio will be set to 92.5%, the initial payout ratio will be set to 85% (see FIG. 4). The initial payout ratio which is set in S2 may be changed if predetermined condition is met (for example, the number of executed games becomes predetermined number).

In S3, the main CPU 41 reads the game program and the like which was verified in S1 from the RAM 43, and executes the main game process. The game in the first embodiment of the slot machine 1 is executed by executing the main game process. The main game process is executed repeatedly during the electronic power source is supplied.

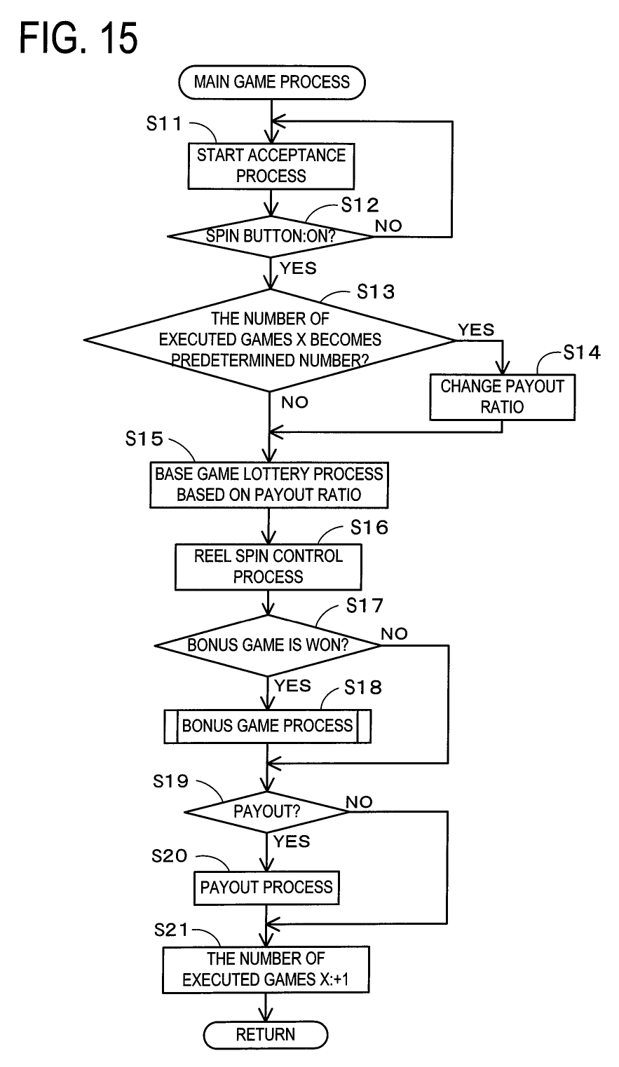

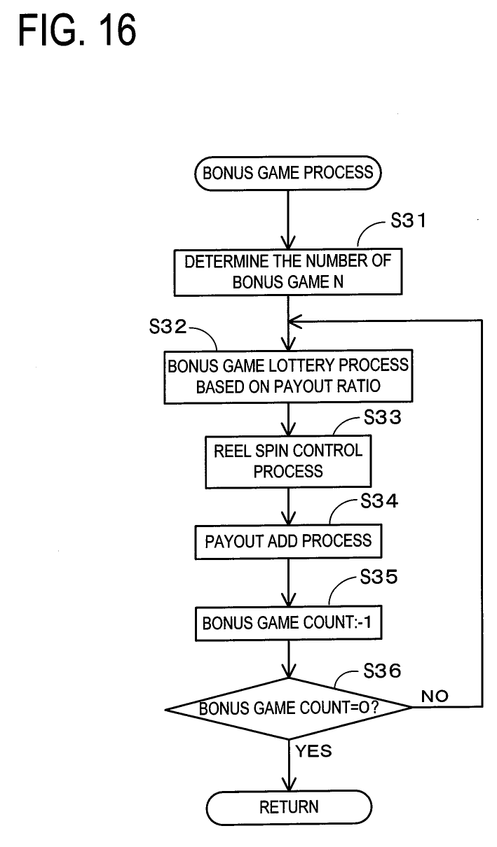

A sub process of the main game process in S3 will be described with reference to FIG. 15. FIG. 15 is a flowchart of the main game process in the first embodiment of the slot machine 1. Here, each of the programs shown in the flowcharts in FIGS. 15 and 16 is stored in the memory card 53. The programs are decompressed to the RAM 43, and decompressed programs are executed by the main CPU 41.

In S11, the main CPU 41 performs predetermined initial setting, and then, executes the start acceptance process as shown in FIG. 15. The coin is inserted and the bet count for the payline is set during the start acceptance process. The coin is inserted by the player, or the bet operation with the use of the 1-bet button 16 or max-bet button 17 is operated by the player.

In S12, the main CPU 41 determines whether or not the spin button 13 is operated. It is determined whether or not the spin button 13 is operated based on that whether or not the input signal is received. If the spin button 13 is not operated (S12:NO), the procedure will be returned to the start acceptance process (S11) again. In that time, some instructions such as to change the bet count are available. On the other hand, if the spin button 17 is operated (S12:YES), the bet count, which is set for the payline L based on the operation of 1-bet button 16 or max-bet button 17, will be subtract from credit count in which the player owns. And, the bet count will be stored in RAM 43 as the bet information.

In S13, it is determined whether or not the number of executed game X becomes predetermined number since the payout ratio is changed (S14) or initial payout ratio is set (S2). If it is determined that the number of executed game X becomes predetermined number (S13:YES), the payout ratio will be changed (S14). On the other hand, if it is determined that the number of executed game X does not predetermined number (S13:NO), the procedure will be shifted to S15.

In the first embodiment of the slot machine 1, as shown in FIG. 4, the payout ratio is changed in predetermined timing based on the whole payout ratio, which may be set any of 87.5%, 90%, or 92.5%, and the number of executed games (except the bonus game). For example, if the whole payout ratio is set to 87.5%, when “2000” games are executed since the payout ratio is set to 85%, the payout ratio will be changed from 85% to 90%. Also, when “500” games are executed since the payout ratio is set to 90%, the payout ratio will be changed from 90% to 95%. Also, “500” games are executed since the payout ratio is set to 95%, the payout ratio will be changed from 95% to 85%.

In S15, the main CPU 41 executes the base game with the use of the reels 5L, 5C, and 5R. Concretely, the main CPU 41 executes random number value generation program included in the lottery program stored in the RAM 43, at result, each of the random number values is generated from the predetermined range of the random number value (“0” to “185” for reel 5L, “0” to “111” for reel 5C, and “0” to “125” for reel 5R). Each code number of reels 5L, 5C, and 5R (see FIG. 2) is determined based on the symbol lottery table, which is associated with payout ratio corresponding to the number of executed games and generated three random number values. After determined code numbers of each reel 5L, 5C, and 5R is stored in RAM 43, the procedure is shifted to S16. Here, the code numbers of each of the reels 5L, 5C, and 5R correspond to the code numbers of the symbols to be stopped in the payline, so the winning combination in current game based on the determined code numbers of each of the reels 5L, 5C, and 5R by the main CPU 41. For example, if it is determined that the numbers of each of the reels 5L, 5C, and 5R are “00”, “00”, and “00”, the combination will be “RED7” by the main CPU 41. In this way, the lottery for the combination is conducted when the code numbers of the each of the reels 5L, 5C, and 5R is determined. Here, a setting table may be used to determine the code numbers of each of the reels 5L, 5C, and 5R based on three random number values. The setting table indicates the relation the range of the random number and the symbols (for example, if the random number value lies in “0” to “20”, the symbol will be BLANK of No. 01, if the random number value lies in “21” to “40”, the symbol will be BLANK of No. 05). Also, the code number will be determined by the position of the symbol. In S15, it is also determined whether the procedure will be shifted to the bonus by randomly. The main CPU 41 determines the random number value from “0” to “99” by executing the lottery program stored in the RAM 43. It is determined whether or not the bonus game will be executed after the base game is executed based on the random number value and the bonus game shift lottery table (FIG. 13).

In S16, the main CPU 41 executes the part of the reel rotation control process. In the reel spin control process, each spinning reels 5L, 5C, and 5R will be stopped so that the symbols corresponding to determined combination of symbols in the base game lottery process (S15) are stopped and displayed on the payline L. The reel spin control process is executed by the main CPU 41 and the sub CPU 61.

Concretely, in the reel spin control process (S16), the main CPU 41 transmits the start signal to the sub CPU 61. The start signal instructs to start the reel spin. When the sub CPU 61 receives the start signal, the sub CPU 61 executes the reel spin process. Namely, each stepping motors 70L, 70C, and 70R are driven by the motor drive circuit 62 and the driver 64. At result, each of the reels 5L, 5C, and 5R will start to spin. After the start signal is transmitted, the main CPU 41 determines a production pattern (for example, the image display on the lower image display panel 6 and output sound from the speaker 28), and the determined production pattern will be conducted. When it becomes predetermined timing in which the reels 5L, 5C, and 5R are to be stopped, the main CPU 41 will transmit the code numbers of the reels stored in the RAM 43 to the sub CPU 61. The sub CPU 61 executes the reel stop process based on the code numbers of the reels. Accordingly, the symbols corresponding to the random result may be stopped and displayed in the each of the display windows 10L, 10C, and 10R.

In S17, the main CPU 41 determines whether or not the bonus game is won in the lottery process of S15. If it is determined that the bonus game is won (S17:YES), the bonus game (which will be described later) will be executed. On the other hand, if it is determined that the bonus game is not won (S17:NO), the procedure will be shifted to S19.

In S19, the main CPU 41 determines whether or not the payout, which is to be provided in the slot machine 1, exists. If the payout to be provided exists (S19:YES), the procedure will be shifted to S20. On the other hand, if the payout to be provided does not exist (S19:NO), the procedure will be shifted to S21.

In S20, if the bonus game was not executed, the payout obtained in the base game (see FIG. 15) is provided to the player. On the other hand, the bonus game was executed, the payout obtained in the base game and bonus game is provided. In this time, if the cashout button 15 is pressed, the coin corresponding to the credit count (for example, one credit is equal to one coin) may be paid or the ticket 25 may be printed. Here, the procedure may or may not be shifted to the bonus game after the payout may be provided.

In S21, the number of executed games X in the slot machine 1 is counted. Concretely, the count is read from the RAM 43, “1” is added to the count, and then, added count is stored in the RAM 43.

The bonus game process executed in S18 in the first embodiment of the slot machine 1 will be described with reference to FIG. 16. FIG. 16 is a flowchart of the bonus game process program in the first embodiment of the slot machine 1.

In S31 of the bonus game process, the main CPU 41 sets the number of executable bonus games N. The number of executable bonus games is determined from any ten to twenty based on the sampled random number value. The number of executable bonus games N is stored in the RAM 43.

In S32, the bonus game lottery process is executed. Concretely, the main CPU 41 executes random number value generation program included in lottery program stored in the RAM 43, at result, each of the random number values of each reel 5L, 5C, and 5R is generated from the predetermined range of the random number value (“0” to “185” for reel 5L, “0” to “111” for reel 5C, and “0” to “125” for the reel 5R). The symbol table is selected from the symbol table D to F based on the payout ratio corresponding to the number of the executed games (for example, if the payout ratio is 85%, the symbol table D (see FIG. 9) will be selected, if the payout ratio is 90%, the symbol table E (see FIG. 10) will be selected, if the payout ratio is 95%, the symbol table E (see FIG. 11) will be selected). The code numbers of the each reel 5L, 5C, and 5R (see FIG. 2) may be determined based on the random number value and the symbol table. The procedure will be shifted to S33 after the code numbers of each reel 5L, 5C, and 5R are stored in the RAM 43. Here, a setting table may be used to determine the code numbers of each of the reels 5L, 5C, and 5R based on three random number values. The setting table indicates the relation the range of the random number and the symbols (for example, if the random number value lies in “0” to “20”, the symbol will be BLANK of No. 01, if the random number value lies in “21” to “40”, the symbol will be BLANK of No. 05). Also, the code number may or may not be determined by the position of the symbol.

In S33, the main CPU 41 executes the reel spin control process. In the reel rotation control process, the reels 5L, 5C, and 5R is controlled so that the combination of stopped and displayed symbols on the payline L is predetermined combination determined in the bonus game lottery process (S13).

In a payout accumulation process S34, the credit count will be accumulated based on the winning combination of the stopped symbols on the payline L in S33. The accumulated credits in S34 will be paid to the player in S20.

In S35, the main CPU 41 reads the number of remaining executed games N, and then, subtracts “1” from the number of remaining executed games N. The subtracted number of remaining executed games N will be re-stored in the RAM 43.

In S36, the main CPU 41 determines whether or not the number of executable bonus games N becomes the predetermined times determined in S31. Concretely, the main CPU 41 determines whether the number of executable bonus games N stored in the RAN 43 becomes “0”. If the number of game times N does not become “0”, namely the number of executable bonus N does not become the predetermined times determined in S31 (S36:NO), the procedure will returned to S32 and the process mentioned above will be executed repeatedly. On the other hand, the number of game times N becomes “0”, namely the number of executable bonus games N becomes the predetermined number determined in S41 (S36:YES), the bonus game process will be finished.

As mentioned above, in the slot machine 1 of the first embodiment, the payout ratio is changed to any of 85%, 90%, or 95% based on the whole payout ratio which is set beforehand and the number of executed games (S14). And the game is controlled based on the symbol lottery table corresponding to the payout ratio which is changed (S15 to S18). At result, the game hall may need not to change the payout ratio, and the slot machine 1 may be executed in various payout ratios. The various payout ratios may be able to prevent the player from concentrating particular gaming machines. Also, the variation in the payout ratio can prevent the player from beginning to feel that the game is monotonous even though the player plays the game for a long time. The slot machine 1 which has plural payout ratios may be provided to various countries of areas in which the regulations therein are different each other. For example, the slot machine 1 can be used in the countries or regions having a lower payout limit of 90% even though the symbol table A and/or D (which are used in the game set to 85%) is used. Because the whole payout ratio will be 90% or over by using every symbol table corresponds to the payout ratio 85%, 90%, and 95% each predetermined number of times. Here, each predetermined number of times corresponding to each of the symbol tables is set beforehand so that the whole payout ratio becomes desired payout ratio. The whole payout ratio may be controlled by using the symbols table A and/or D (which are used in the game set to 85%) together with the symbols table B, C, E, and F (which are used in the game set to 90% or 95%). Each predetermined number of times may be used in the program of the slot machine 1.

### Second Embodiment

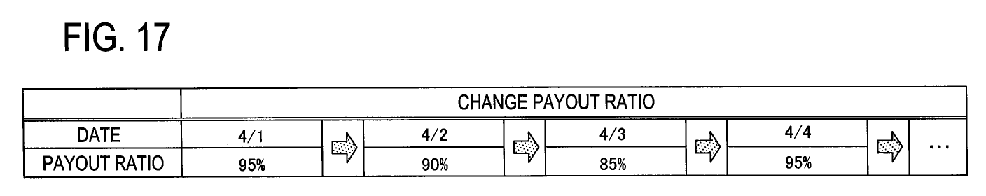

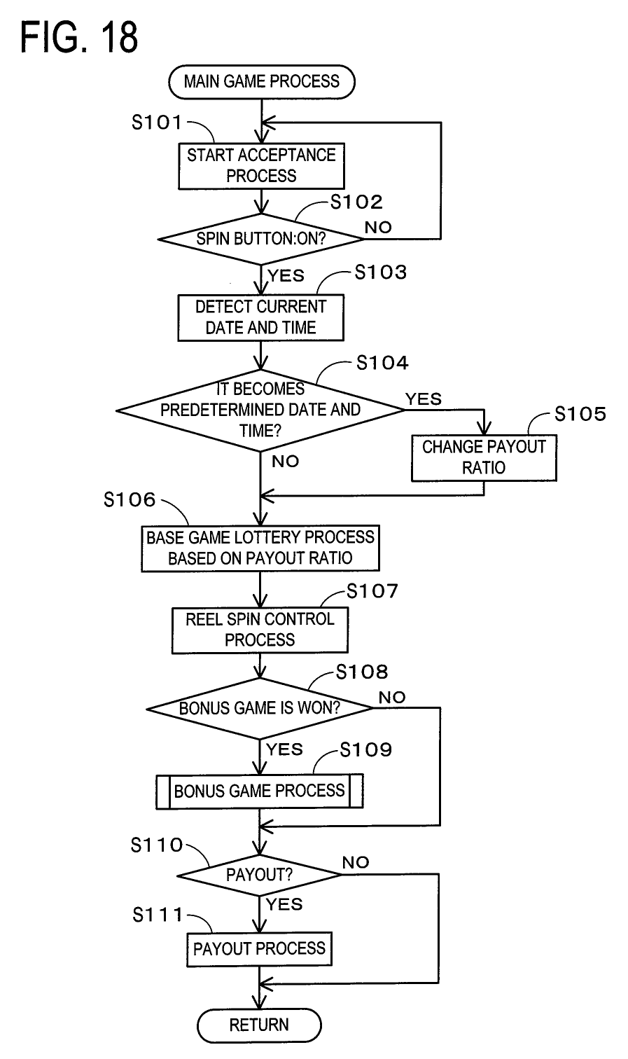

Next, a slot machine of the second embodiment embodying one or more aspects of the invention will be described with reference to FIGS. 17 and 18. The reference characters of FIGS. 16 and 17, which are the same as the reference characters of FIGS. 1 to 16, designating the same parts.

A structure of the slot machine of the second embodiment is almost same as in the first embodiment of the slot machine. A control process of the slot machine in the second example according to one or more aspects is almost same as the slot machine of the first example according to one or more aspects. Here, in the slot machine of the first embodiment, the payout ratio is changed based on the whole payout ratio and the number of times of the executed games, on the other hand, in the slot machine of the second embodiment, the payout is changed with the use of the current date/time.

The payout ratio, which is set by the slot machine of the second embodiment, will be described with reference to FIG. 17. The payout in the slot machine of the second embodiment is set to any of 85%, 90%, or 95%. Here, the kind of the payout ratio is variable and the number of the kinds is variable. For example, the game is executed with the payout ratio 95% at 04/01 (April 1st). On 04/02 0:00 (April, 2nd at midnight), the payout ratio will be changed from 95% to 90%, and the game will be executed with the payout ratio 90%. When it comes 04/03 0:00 (April, 3rd at midnight), the payout ratio will be changed from 90% to 85%, and the game will be executed with the payout ratio 85%. On 04/04 0:00 (April, 4th at midnight), the payout ratio will be changed again to 95%, and the game will be executed with the payout ratio 95%. In this embodiment, above process cycle may be executed every twenty four hours. Here, the relation between the date/time and the payout ratio may or may not be determined beforehand so as to meet the whole payout ratio.

A sub process of the main game process executed in the slot machine of the second embodiment will be described with reference to FIG. 18. FIG. 18 is a flowchart of the main game process of the slot machine of the second embodiment. Here, each of the programs shown in the flowchart of FIG. 18 is stored in the memory card 53. The programs are decompressed to the RAM 43, and decompressed programs are executed by the main CPU 41.

In S101, the main CPU 41 performs predetermined initial setting, and then, executes the start acceptance process as shown in FIG. 18. The coin is inserted and the bet count for the payline is set during the start acceptance process. The coin is inserted by the player, or the bet operation with the use of the 1-bet button 16 or max-bet button 17 is conducted by the player.

In S102, the main CPU 41 determines whether or not the spin button 13 is operated. It is determined whether or not the spin button 13 is operated based on that whether or not the input signal is received. If the spin button 13 is not operated (S102:NO), the procedure will be returned to the start acceptance process (S101) again. In that time, some instructions such as to change the bet count are available. On the other hand, if the spin button 17 is operated (S12:YES), the bet count, which is set for the payline L based on the operation of 1-bet button 16 or max-bet button 17, will be subtract from credit count in which the player owns. And, the bet count will be stored in RAM 43 as the bet information.

In S103, the main CPU 41 detects the current date/time based on the information from the timer 29. The CPU 41 determines whether or not the current data/time becomes predetermined data/time in which the payout ratio will be changed. The payout ratio is set by the slot machine beforehand. If it is determined that the current data/time becomes predetermined data/time (S104:YES), the payout ratio will be changed to predetermined payout ratio (S105). On the other hand, if it is determined that the current data/time doesn't become that data/time, the procedure will be shifted to S106.

In the slot machine of second embodiment, as shown in FIG. 17, the payout ratio is changed in predetermined timing sequentially. For example, if it is determined that it is 04/02 0:00 (April, 2nd at midnight), the payout ratio will be changed from 95% to 90%. For example, if it is determined that it is 04/03 0:00 (April, 3rd at midnight), the payout ratio will be changed from 90% to 85%.

In S106, the main CPU 41 executes with the use of the reels 5L, 5C, and 5R. Concretely, the symbol table selected from the symbol table A to C based on the payout ratio corresponding to current date/time (for example, if the payout ratio is 85%, the symbol table A (see FIG. 6) will be selected, if the payout ratio is 90%, the symbol table B (see FIG. 7) will be selected, if the payout ratio is 95%, the symbol table C (see FIG. 8) will be selected). The code numbers of the each reel 5L, 5C, and 5R (see FIG. 2) may be determined based on the random number value and the symbol table. The procedure will be shifted to S107 after the code numbers of each reel 5L, 5C, and 5R are stored in the RAM 43. In S106, the lottery for whether the procedure will be shifted to the bonus game will be also executed. The main CPU 41 determines the random number value from “0” to “99” by executing the lottery program stored in the RAM 43. It is determined whether or not the bonus game will be executed after the base game is executed based on the random number value and the bonus game shift lottery table (FIG. 13).

In S107, the main CPU 41 executes the reel spin control process. In the reel spin control process, the reels 5L, 5C, and 5R is controlled so that the combination of stopped and displayed symbols on the payline L is predetermined combination determined in the bonus game lottery process (S106). The reel spin control process is executed by the main CPU 41 and the sub CPU 61.

The processes of S108 to S111 are same as the processes as S17 to S20 (in the main game process shown in FIG. 15 of the slot machine 1 of the first embodiment), so this explanation will be omitted.

As mentioned above, in the slot machine 1 of the second embodiment, the payout ratio is changed to any of 85%, 90%, or 95% (S105) based on the current date/time. And the game is controlled based on the symbol lottery table corresponding to the payout ratio which is changed (S106 to S109). At result, the game hall may need not to change the payout ratio, and the slot machine 1 may be executed in various payout ratios. The various payout ratios can prevent the player from concentrating particular gaming machines. Also, the variation in the payout ratio can prevent the player from beginning to feel that the game is monotonous even though the player plays the game for a long time. The payout ratio is changed in predetermined date/time, so the payout ratio will be certainly changed based on the elapse.

### Third Embodiment

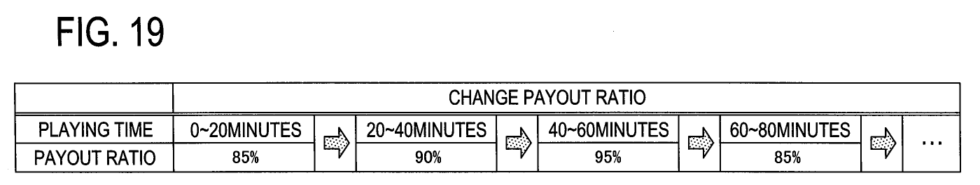

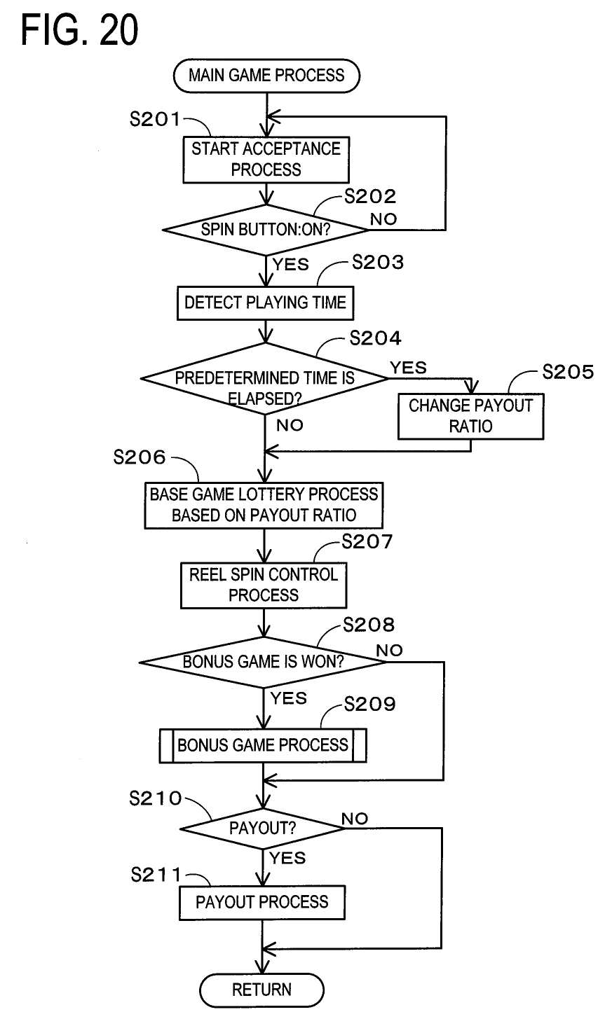

Next, a slot machine of the third embodiment embodying one or more aspects of the invention will be described with reference to FIGS. 19 and 20. The reference characters of FIGS. 19 and 20, which are the same as the reference characters of FIGS. 1 to 16, designate the same part.

A structure of the slot machine of the third embodiment is almost same as in the first embodiment of the slot machine. A control process of the slot machine in the third example according to one or more aspects is almost same as the slot machine of the first example according to one or more aspects. Here, in the slot machine of the first embodiment, the payout ratio is changed based on the whole payout ratio and the number of times of the executed games, on the other hand, in the slot machine of the third embodiment, the payout is changed with the use of on a playing time.

The payout ratio which is set by the slot machine of the third embodiment will be described with reference to FIG. 19. The payout ratio of the slot machine of the third embodiment is set to any of 85%, 90%, or 95%. Here, the kinds of the payout ratio are variable and the number of the kinds thereof is variable. For example, the game is executed with the payout ratio 85% during from the start time (the slot machine is operated) to twenty minutes since the slot machine is operated. During from twenty minutes to forty minutes since the slot machine 1 is operated, the game will be executed with payout ratio 90%. During from forty minutes to sixty minute since the slot machine 1 is operated, the game will be executed with the payout ratio 95%. Also, when the playing time elapses sixty minute, the payout ratio will be changed again to 85%. Above process cycle may be executed every twenty minutes. Here, the relation between playing time and the payout ratio may or may not be determined beforehand so as to meet the whole payout ratio.

A sub process of the main game process executed in the slot machine of the third embodiment will be described with reference to FIG. 20. FIG. 20 is a flowchart of the main game process of the slot machine of the third embodiment. Here, each of the programs shown in the flowcharts shown in FIG. 20 is stored in the memory card 53. The programs are decompressed to the RAM 43, and decompressed programs are executed by the main CPU 41.

In S201, the main CPU 41 performs predetermined initial setting, and then, executes the start acceptance process as shown in FIG. 20. The coin is inserted and the bet count for the payline is set during the start acceptance process. The coin is inserted by the player, or the bet operation with the use of the 1-bet button 16 or max-bet button 17 is operated by the player.

In S202, the main CPU 41 determines whether or not the spin button 13 is operated. It is determined whether or not the spin button 13 is operated based on that whether or not the input signal is received. If the spin button 13 is not operated (S202:NO), the procedure will be returned to the start acceptance process (S201) again. In that time, some instructions such as to change the bet count are available. On the other hand, if the spin button 17 is operated (S202:YES), the bet count, which is set for the payline L based on the operation of 1-bet button 16 or max-bet button 17, will be subtract from credit count in which the player owns. And, the bet count will be stored in RAM 43 as the bet information.

In S203, the main CPU 41 detects the playing time based on the information from the timer 29. The CPU 41 determines whether or not the detected playing time becomes predetermined time in which the payout ratio will be changed. The payout ratio is set by the slot machine beforehand. If it is determined that the playing time becomes predetermined time (S204:YES), the payout ratio will be changed to predetermined payout ratio (S205). On the other hand, if it is determined that the playing time doesn't become predetermined time (S04:NO), the procedure will be shifted to S206.

In the slot machine of third embodiment, as shown in FIG. 19, the payout ratio is changed in predetermined timing sequentially. For example, if it is determined that the playing time elapses twenty minutes, the payout ratio will be changed from 85% to 90%. For example, if it is determined that the playing time elapses forty minutes, the payout ratio will be changed from 90% to 95%.

In S206, the main CPU 41 executes with the use of the reels 5L, 5C, and 5R. Concretely, the symbol table selected from the symbol table A to C based on the payout ratio corresponding to playing time (for example, if the payout ratio is 85%, the symbol table A (see FIG. 6) will be selected, if the payout ratio is 90%, the symbol table B (see FIG. 7) will be selected, if the payout ratio is 95%, the symbol table C (see FIG. 8) will be selected). The code numbers of the each reel 5L, 5C, and 5R (see FIG. 2) may be determined based on the random number value and the symbol table. The procedure will be shifted to S207 after the code numbers of each reel 5L, 5C, and 5R are stored in the RAM 43. In S206, the lottery for whether the procedure will be shifted to the bonus game will be also executed. The main CPU 41 determines the random number value from “0” to “99” by executing the lottery program stored in the RAM 43. It is determined whether or not the bonus game will be executed after the base game is executed based on the random number value and the bonus game shift lottery table (FIG. 13).

In S207, the main CPU 41 executes the reel spin control process. In the reel rotation control process, the reels 5L, 5C, and 5R is controlled so that the combination of stopped and displayed symbols on the payline L is predetermined combination determined in the bonus game lottery process (S206). The reel rotation control process is executed by the main CPU 41 and the sub CPU 61.

The processes of S208 to S211 are same as the processes as S17 to S20 (in the main game process shown in FIG. 15 of the slot machine 1 of the first embodiment), so this explanation will be omitted.

As mentioned above, in the slot machine 1 of the third embodiment, the payout ratio is changed to any of 85%, 90%, or 95% (S205) based on the playing time. And the game is controlled based on the symbol lottery table corresponding to the payout ratio which is changed (S206 to S209). At result, the game hall may need not to change the payout ratio, and the slot machine 1 may be executed in various payout ratios. The various payout ratios can prevent the player from concentrating particular gaming machines. Also, the variation in the payout ratio can prevent the player from beginning to feel that the game is monotonous even though the player plays the game for a long time. Here, the player may play the game for an average of twenty minutes, so if the payout is changed every twenty minute, the payout can be changed at least once while the player plays the game. Accordingly, the player may develop an interest in the game. In one of more aspects, the slot machine 1 may include a detection device. The detection device determines whether or not the player uses the slot machine. The detection device may or may not be a light sensor or individual identification device (for example, with the use of membership card). The playing time may or may not be measured by the detection device.

### Fourth Embodiment

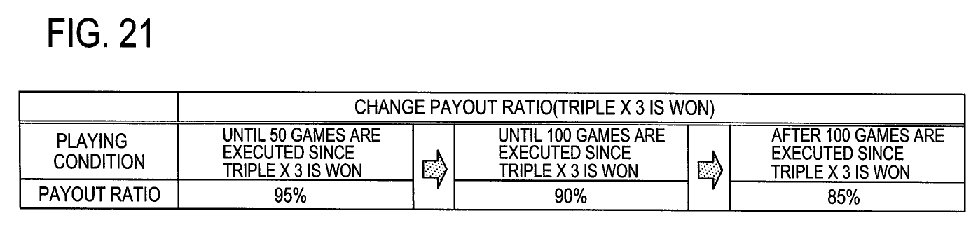

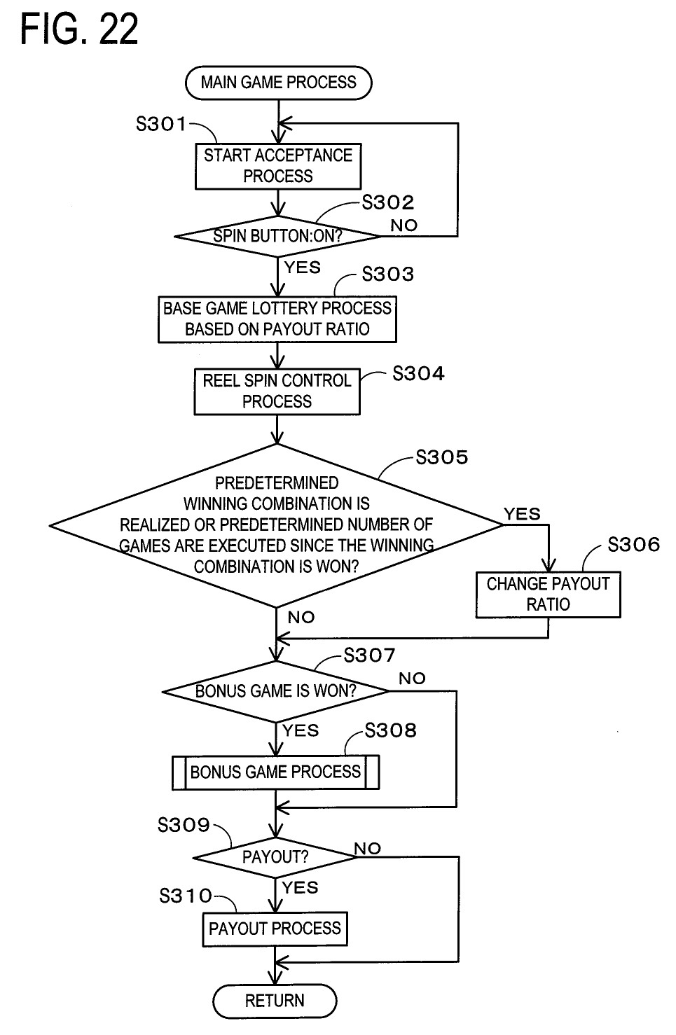

Next, a slot machine of the fourth embodiment embodying one or more aspects of the invention will be described with reference to FIGS. 21 and 22. The reference characters of FIGS. 21 and 22, which are the same as the reference characters of FIGS. 1 to 16, designate the same part.

A structure of the slot machine of the fourth embodiment is almost same as in the first embodiment of the slot machine. A control process of the slot machine in the fourth example according to one or more aspects is almost same as the slot machine of the first example according to one or more aspects. Here, in the slot machine of the first embodiment, the payout ratio is changed based on the whole payout ratio and the number of times of the executed games, on the other hand, in the slot machine of the second embodiment, the payout is changed with the used of at least realized winning combination.

The payout ratio which is set by the slot machine of the fourth embodiment will be described with reference to FIG. 21. The payout in the slot machine of the forth embodiment is set to any of 85%, 90%, or 95% based on the realized winning combination and the number of execute games since the winning combination is realized. For example, the game is executed with the payout ratio 95% during, from the time when the winning combination in which three “TRIPLE” symbols are stopped and displayed on the payline, to the time when “50” games are executed since the winning combination is realized. After that, the game is executed with the payout ratio 90% during, from the time when “50” games are executed since the winning combination was realized to the time when “100” games are executed after the winning combination was realized. After that, the game is executed with the payout ratio 90% after “100” games are executed since the winning combination was realized. Here, the winning combination is variable. Also, the relation between the number of executed games since the winning combination is won and the payout ratio may be determined beforehand so as to meet the whole payout ratio.

A sub process of the main game process executed in the slot machine of the fourth embodiment will be described with reference to FIG. 22. FIG. 22 is a flowchart of the main game process of the slot machine of the fourth embodiment. Here, each of the programs shown in the flowcharts shown in FIG. 22 is stored in the memory card 53. The programs are decompressed to the RAM 43, and decompressed programs are executed by the main CPU 41.

In S301, the main CPU 41 performs predetermined initial setting, and then, executes the start acceptance process as shown in FIG. 22. The coin is inserted and the bet count for the payline is set during the start acceptance process. The coin is inserted by the player, or the bet operation with the use of the 1-bet button 16 or max-bet button 17 is conducted by the player.

In S302, the main CPU 41 determines whether or not the spin button 13 is operated. It is determined whether or not the spin button 13 is operated based on that whether or not the input signal is received. If the spin button 13 is not operated (S302:NO), the procedure will be returned to the start acceptance process (S301) again. In that time, some instructions such as to change the bet count are available. On the other hand, if the spin button 17 is operated (S302:YES), the bet count, which is set for the payline L based on the operation of 1-bet button 16 or max-bet button 17, will be subtract from credit count in which the player owns. And, the bet count will be stored in RAM 43 as the bet information.

In S303, the main CPU 41 executes with the use of the reels 5L, 5C, and 5R. Concretely, the symbol table selected from the symbol table A to C based on the payout ratio corresponding to current playing condition (for example, if the payout ratio is 85%, the symbol table A (see FIG. 6) will be selected, if the payout ratio is 90%, the symbol table B (see FIG. 7) will be selected, if the payout ratio is 95%, the symbol table C (see FIG. 8) will be selected). The code numbers of the each reel 5L, 5C, and 5R (see FIG. 2) may be determined based on the random number value and the symbol table. The procedure will be shifted to S207 after the code numbers of each reel 5L, 5C, and 5R are stored in the RAM 43. In S303, the lottery for whether the procedure will be shifted to the bonus game will be also executed. The main CPU 41 determines the random number value from “0” to “99” by executing the lottery program stored in the RAM 43. It is determined whether or not the bonus game will be executed after the base game is executed based on the random number value and the bonus game shift lottery table (FIG. 13).

In S304, the main CPU 41 executes the reel spin control process. In the reel rotation control process, the reels 5L, 5C, and 5R is controlled so that the combination of stopped and displayed symbols on the payline L is predetermined combination determined in the bonus game lottery process (FIG. 303). The reel rotation control process is executed by the main CPU 41 and the sub CPU 61.

In S305, the main CPU 41 determines whether or not the combination “TRIPLE” is won (which is realized when three symbol “TRIPLE” are stopped on the payline), or the number of executed games since the winning combination “TRIPLE” is won previously becomes predetermined number. If it is determined that the condition is met (S305:YES), the payout ratio which is set will be changed (S306). On the other hand, it is determined that the condition is not met (S305: NO), the procedure will be shifted to S307.

In the slot machine 1 of the fourth embodiment, the payout may be changed based on the realized winning combination and the executed games since the winning is realized sequentially as shown in FIG. 21. For example, if it is determined that the winning combination “TRIPLE” is won, the payout ratio will be changed to 95%. If the number of executed games since the winning combination “TRIPLE” is won becomes fifty games, the payout ratio will be changed from 95% to 90%. If the number of executed games since the winning combination “TRIPLE” is won becomes one hundred games, the payout ratio will be changed from 90% to 85%.

The processes of S307 to S310 are same as the processes as S17 to S20 (in the main game process shown in FIG. 15 of the slot machine 1 of the first embodiment), so this explanation will be omitted.

As mentioned above, in the slot machine 1 of the fourth embodiment, the payout ratio is changed to any of 85%, 90%, or 95% (S306) based on the realized winning combination. And the game is controlled based on the symbol lottery table corresponding to the payout ratio which is changed (S303 to S308). At result, the game hall may need not to change the payout ratio, and the slot machine 1 may be executed in various payout ratios. Also, the variation in the payout ratio based on the realized winning combination can prevent the player from beginning to feel that the game is monotonous even though the player plays the game for a long time. The payout ratio is changed based on the realized winning combination, so the player may develop an interest in the game and the player will be able to play the game in the slot machine 1 for a longer time. Here, the symbol tables to be changed may or may not correspond to every winning combination beforehand. Also, the symbol tables may or may not be changed based on predetermined winning combination.

### Fifth Embodiment

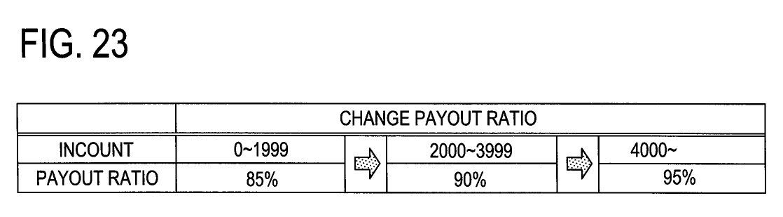

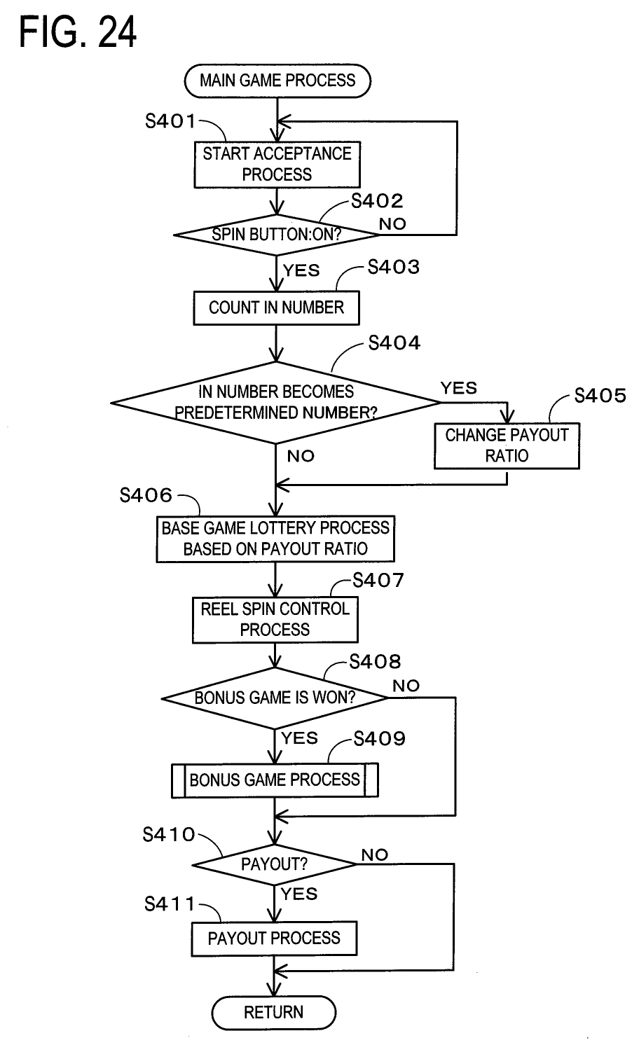

Next, a slot machine of the fifth embodiment embodying one or more aspects of the invention will be described with reference to FIGS. 23 and 24. The reference characters of FIGS. 23 and 24, which are the same as the reference characters of FIGS. 1 to 16, designate the same part.

A structure of the slot machine of the fifth embodiment is almost same as in the first embodiment of the slot machine. A control process of the slot machine in the second example according to one or more aspects is almost same as the slot machine of the first example according to one or more aspects. Here, in the slot machine of the first embodiment, the payout ratio is changed based on the whole payout ratio and the number of times of the executed games, on the other hand, in the slot machine of the fifth embodiment, the payout is changed based on the number of coins inserted from the coin insertion slot 21 (and/or the coin count corresponding to the bill and/or the ticket 25 inserted from the bill verifier 22) to the slot machine.

The payout ratio which is set by the slot machine of the fifth embodiment will be described with reference to FIG. 23. The payout in the slot machine of the fifth embodiment is set to any of 85%, 90%, or 95% based on the number of inserted coins (value) from the coin insertion slot 21 (and/or the coin count corresponding to the bill or the ticket 25 inserted from the bill verifier 22) by the player. Here, the kind of the payout ratio is variable and the number of the kind is variable. For example, the game will executed with the payout ratio 85% in a case where the number of inserted coins from the coin insertion slot 21 (and/or the coin count corresponding to the bill or the ticket 25 inserted from the bill verifier 22) by the player (hereinafter, “IN count”) is “0” to “1999”. The game will be executed with the payout ratio 90% in a case where the IN count is “2000” to “3999”. The game will be executed with the payout ratio 95% in a case where the IN count is more than “3999”.

A sub process of the main game process executed in the slot machine of the fifth embodiment will be described with reference to FIG. 24. FIG. 24 is a flowchart of the main game process of the slot machine of the fifth embodiment. Here, each of the programs shown in the flowcharts shown in FIG. 24 is stored in the memory card 53. The programs are decompressed to the RAM 43, and decompressed programs are executed by the main CPU 41.

In S401, the main CPU 41 performs predetermined initial setting, and then, executes the start acceptance process as shown in FIG. 24. The coin is inserted and the bet count for the payline is set during the start acceptance process. The coin is inserted by the player, or the bet operation with the use of the 1-bet button 16 or max-bet button 17 is operated by the player.

In S402, the main CPU 41 determines whether or not the spin button 13 is operated. It is determined whether or not the spin button 13 is operated based on that whether or not the input signal is received. If the spin button 13 is not operated (S402:NO), the procedure will be returned to the start acceptance process (S401) again. In that time, some instructions such as to change the bet count are available. On the other hand, if the spin button 17 is operated (S402:YES), the bet count, which is set for the payline L based on the operation of 1-bet button 16 or max-bet button 17, will be subtract from credit count in which the player owns. And, the bet count will be stored in RAM 43 as the bet information.

In S403, the main CPU 41 counts the number of inserted coins (value) from the coin insertion slot 21 (and/or the coin count corresponding to the bill and/or the ticket 25 inserted from the bill verifier 22). Concretely, the coin counter 21C arranged at the coin insertion slot 21 detects the number of inserted coins (and/or the bill verifier 22 counts the coin count corresponding to the bill and/or the ticket 25) in the start acceptance process (S401), and the counted number of the coins will be stored in the RAM 43.

In S404, it is determined whether or not the counted IN count becomes the predetermined count which is set by the slot machine. The predetermined indicates the timing when the payout ratio is changed. If it is determined that IN count becomes the predetermined count (S404: YES), the payout which is set will be changed (S405). On the other hand, if it is determined that IN count does not become the predetermined count (S404: NO), the procedure will be shifted to S406.

In the slot machine of the fifth embodiment, the payout ratio will be sequentially changed based on IN count inserted to the slot machine before now. For example, if the IN count becomes “4000”, the payout ratio will be changed from 90% to 95%. Here, the symbol table to be used will be changed every 2000 coins are inserted, however, the count is variable. Also, the count may be change each time.

In S406, the main CPU 41 executes with the use of the reels 5L, 5C, and 5R. Concretely, the symbol table selected from the symbol table A to C based on the payout ratio corresponding to IN count (for example, if the payout ratio is 85%, the symbol table A (see FIG. 6) will be selected, if the payout ratio is 90%, the symbol table B (see FIG. 7) will be selected, if the payout ratio is 95%, the symbol table C (see FIG. 8) will be selected). The code numbers of the each reel 5L, 5C, and 5R (see FIG. 2) may be determined based on the random number value and the symbol table. The procedure will be shifted to S207 after the code numbers of each reel 5L, 5C, and 5R are stored in the RAM 43. In S406, the lottery for whether the procedure will be shifted to the bonus game will be also executed. The main CPU 41 determines the random number value from “0” to “99” by executing the lottery program stored in the RAM 43. It is determined whether or not the bonus game will be executed after the base game is executed based on the random number value and the bonus game shift lottery table (FIG. 13).

In S407, the main CPU 41 executes the reel spin control process. In the reel rotation control process, the reels 5L, 5C, and 5R is controlled so that the combination of stopped and displayed symbols on the payline L is predetermined combination determined in the bonus game lottery process (S406). The reel rotation control process is executed by the main CPU 41 and the sub CPU 61.

The processes of S408 to S411 are same as the processes as S17 to S20 (in the main game process shown in FIG. 15 of the slot machine 1 of the first embodiment), so this explanation will be omitted.

As mentioned above, in the slot machine 1 of the fifth embodiment, the payout ratio is changed to any of 85%, 90%, or 95% (S405) based on the IN count (which corresponds to the inserted gamine medium value). And the game is controlled based on the symbol lottery table corresponding to the payout ratio which is changed (S406 to S409). At result, the game hall may need not to change the payout ratio, and the slot machine 1 may be executed in various payout ratios. The various payout ratios can prevent the player from concentrating particular gaming machines. Also, the variation in the payout ratio can prevent the player from beginning to feel that the game is monotonous even though the player plays the game for a long time. The payout ratio will be increased according to the number of inserted coins, so the player may develop an interest in the game and the player can spend more coins.

### Sixth Embodiment

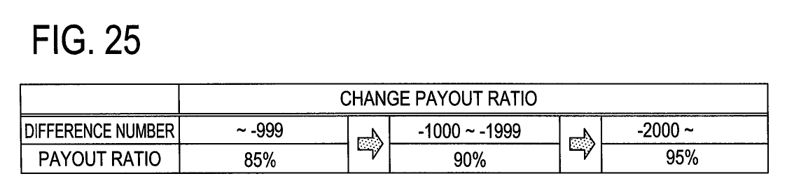

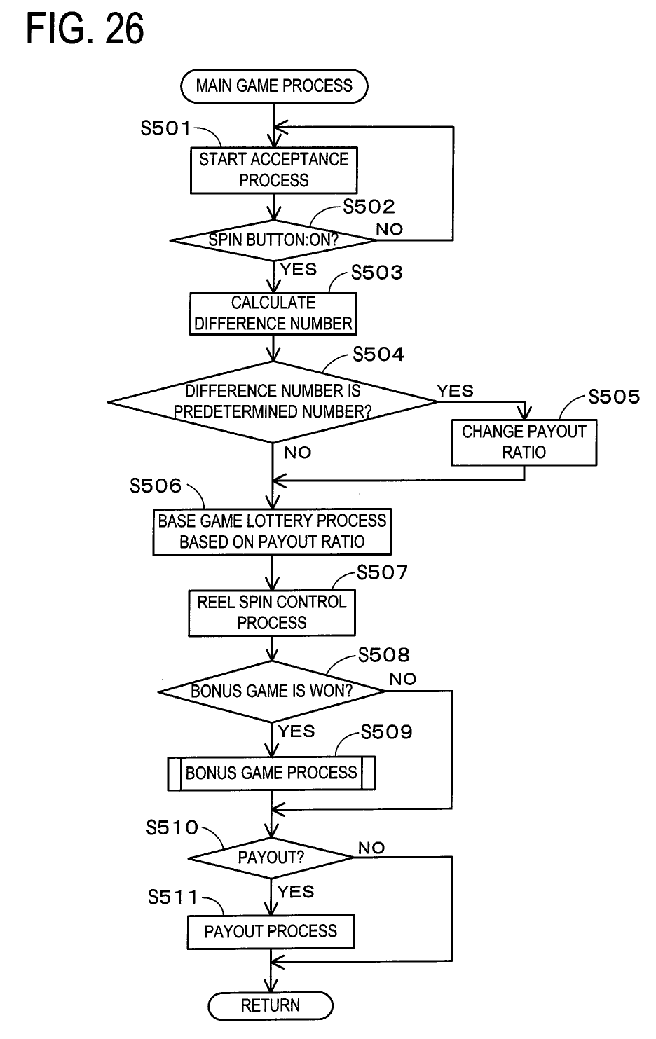

Next, a slot machine of the sixth embodiment embodying one or more aspects of the invention will be described with reference to FIGS. 25 and 26. The reference characters of FIGS. 25 and 26, which are the same as the reference characters of FIGS. 1 to 16, designate the same part.

A structure of the slot machine of the sixth embodiment is almost same as in the first embodiment of the slot machine. A control process of the slot machine in the sixth example according to one or more aspects is almost same as the slot machine of the first example according to one or more aspects. Here, in the slot machine of the first embodiment, the payout ratio is changed based on the whole payout ratio and the number of times of the executed games, on the other hand, in the slot machine of the sixth embodiment, the payout is changed based on a difference number between the number of output coins and the number of input coins from the slot insertion slot 21.

The payout ratio, which is set by the slot machine of the sixth embodiment will be described with reference to FIG. 25. The payout in the slot machine of the sixth embodiment is set to any of 85%, 90%, or 95% based on the difference number according to the number of output coins (value) and the number of input coins (value) from the slot insertion slot 21 by the player. For example, if the difference number between the number of output coins (hereinafter, “OUT count”) and the number of inserted coins from the coin insertion slot 21 (hereinafter, “IN count”) is “−999” (minus 999) and more (namely, in a case where IN count is equal to OUT count, OUT count is more than IN count, or IN count is not 999 more than OUT count), the game will be executed with the payout ratio 85%. If the difference number between the OUT count and the IN count is “−1000” to “−1999” (namely, in a case where the IN count is 1000 to 1999 more than the OUT count), the game will be executed with the payout ratio 90%. If the difference number between the OUT count and the IN count is not over “−2000” (namely, in a case where the IN count is 2000 and above more than the OUT count), the game will be executed with the payout ratio 95%. Here, the definition of the difference number is variable. For example, the difference number may be defined as the ratio by value of output to bet. Also, the difference number may be defined as the difference between output value and bet value.

A sub process of the main game process executed in the slot machine of the sixth embodiment will be described with reference to FIG. 26. FIG. 26 is a flowchart of the main game process of the slot machine of the sixth embodiment. Here, each of the programs shown in the flowchart shown in FIG. 26 is stored in the memory card 53. The programs are decompressed to the RAM 43, and decompressed programs are executed by the main CPU 41.

In S501, the main CPU 41 performs predetermined initial setting, and then, executes the start acceptance process as shown in FIG. 26. The coin is inserted and the bet count for the pay line is set during the start acceptance process. The coin is inserted by the player, or the bet operation with the use of the 1-bet button 16 or max-bet button 17 is operated by the player.

In S502, the main CPU 41 determines whether or not the spin button 13 is operated. It is determined whether or not the spin button 13 is operated based on that whether or not the input signal is received. If the spin button 13 is not operated (S502:NO), the procedure will be returned to the start acceptance process (S501) again. In that time, some instructions such as to change the bet count are available. On the other hand, if the spin button 17 is operated (S502:YES), the bet count, which is set for the pay line L based on the operation of 1-bet button 16 or max-bet button 17, will be subtract from credit count in which the player owns. And, the bet count will be stored in RAM 43 as the bet information.

In S503, the main CPU 41 may calculate the difference number between the number of output coins (value) to the player and the number of inserted coins (value) from the coin insertion slot 21 by the player. Concretely, the number of inserted coins from the coin insertion slot 21 is detected by the coin counter 21C arranged at the coin insertion slot 21 in the start acceptance process (S501), and the detected number is stored in the RAM 43. Also, the number of output coins paid in the payout process (S511) is stored in the RAM 32. The main CPU 41 reads the numbers and calculates the difference number.

In S504, it is determined whether or not the calculated difference number becomes the predetermined number, which is set by the slot machine. The predetermined indicates the timing when the payout ratio is changed. If it is determined that the calculated difference number becomes the predetermined number (S504: YES), the payout, which is set will be changed (S505). On the other hand, if it is determined that the calculated difference number does not become the predetermined number (S504: NO), the procedure will be shifted to S506 is set will be changed (S505).

In the slot machine of the sixth embodiment, the payout ratio will be sequentially changed based on the difference number according to IN count to the slot machine and OUT count to the player before now. For example, if the difference number (OUT count minus IN count) becomes “−1000” (namely, in a case where IN count is 1000 and above more than the OUT count), the payout ratio will be changed from 85% to 90%. If the difference number (OUT count minus IN count) becomes “−2000” (namely, in a case where IN count is “2000” and above more than the OUT count), the payout ratio will be changed from 90% to 95%. Here, if the difference (OUT count minus IN count) number is minus, the symbol table for the payout 95% may be used. Also, if the difference number is plus, the symbols table for the payout 85% may be used. Further, the relation between the difference number and the payout ratio may be variable.

In S506, the main CPU 41 executes the base game lottery process with the use of the reels 5L, 5C, and 5R. Concretely, the symbol table selected from the symbol table A to C based on the payout ratio corresponding to the difference number (for example, if the payout ratio is 85%, the symbol table A (see FIG. 6) will be selected, if the payout ratio is 90%, the symbol table B (see FIG. 7) will be selected, if the payout ratio is 95%, the symbol table C (see FIG. 8) will be selected). The code numbers of the each reel 5L, 5C, and 5R (see FIG. 2) may be determined based on the random number value and the symbol table. The procedure will be shifted to S107 after the code numbers of each reels 5L, 5C, and 5R are stored in the RAM 43. In S106, the lottery for whether the procedure will be shifted to the bonus game will be also executed. The main CPU 41 determines the random number value from “0” to “99” by executing the lottery program stored in the RAM 43. It is determined whether or not the bonus game will be executed after the base game is executed based on the random number value and the bonus game shift lottery table (FIG. 13).

In S507, the main CPU 41 executes the reel spin control process. In the reel rotation control process, the reels 5L, 5C, and 5R is controlled so that the combination of stopped and displayed symbols on the pay line L is predetermined combination determined in the bonus game lottery process (S506). The reel spin control process is executed by the main CPU 41 and the sub CPU 61.

The processes of S508 to S511 are same as the processes as S17 to S20 (in the main game process shown in FIG. 15 of the slot machine 1 of the first embodiment), so this explanation will be omitted.

As mentioned above, in the slot machine 1 of the sixth embodiment, the payout ratio is changed to any of 85%, 90%, or 95% (S405) based on the difference number according to the input gaming medium value and the output gaming medium value. And the game is controlled based on the symbol lottery table corresponding to the payout ratio, which is changed (S506 to S509). At result, the game hall may need not to change the payout ratio, and the slot machine 1 may be executed in various payout ratios. The various payout ratios can prevent the player from concentrating particular gaming machines. Also, the variation in the payout ratio can prevent the player from beginning to feel that the game is monotonous even though the player plays the game for a long time. Also, the payout ratio will be increased according to decrease in the factual payout ratio, so the balance of out/in value for the player may be maintained.

Here, aspects of the present invention are not limited to the above embodiment and various changes and modification can be done within the scope of the present invention. For example, in one or more embodiments, the symbol tables for both the base game and the bonus game are changed based on the payout ratio, which is set. However, the invention is not so limited. For example, the symbol table for the bonus game may be fixed and only the symbol table for the base game may be changed. Also, the symbol table for the base game may be fixed and only the symbol table for the bonus game may be changed. Further, the symbol tables for both the base game and the bonus game are always fixed and the bonus game shift lottery table may be changed so that the payout can be adjusted.

In one or more embodiments, the free game, which the reels 5L, 5C, and 5R are span predetermined times without the consumption credit may be executed as the bonus game. However, the invention is not so limited. For example, a selection game, which the payout corresponding to selected selection item from plural selection items displayed on the lower image display panel 6 will be provided, may be executed as the bonus game.

In one or more embodiments, the payout ratios (85%, 90%, or 95%) is changed based on predetermined information (for example, the number of executed games, or current data/time). However, the invention is not so limited. For example, the slot machine according to one or more aspect may include some variation patterns. Also, one variation pattern may be selected and the payout ratio may be changed based on the selected variation pattern. Further, items of the first embodiment to the sixth embodiment may be combined. For example, the variation pattern may be changed when predetermined condition (for example, the number of executed games or time) is met.

In one or more embodiment, the payout ratio is always changed when predetermined condition (for example, the number of executed games becomes predetermined number or current time/date becomes predetermined time/date). However, the invention is not so limited. For example, when predetermined condition is met, it is determined whether or not the payout ratio will be changed by lottery, and then the payout ratio may be changed based on the random result.

In one or more embodiment, the slot machines include three symbol tables (85%, 90%, and 95%). However, the invention is not so limited. For example, the number of the symbol tables is variable. Also, it may be determined whether or not the symbol table will be changed by lottery every game. For example, if the game is executed with the symbol table for the payout ratio 95%, it may be determined whether or not the symbol table will be changed to 90% or 85% every game. If the game is executed with the symbol table for the payout ratio 95%, it may be determined whether or not the symbol table will be changed to 90% or 85% every game. If the game is executed with the symbol table for the payout ratio 90%, it may be determined whether or not the symbol table will be changed to 85% or 95% every game. Here, the determination process may be executed every 3 games. Also, it may be determined whether or not the symbol table will be changed by lottery every predetermined time. Further, it may be determined which the symbols table will be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine controlled based on a payout ratio comprising:
a processor programmed to change the payout ratio based on information.

2. The gaming machine according to claim 1, wherein the information includes a predetermined whole payout ratio and the number of executed games.

3. The gaming machine according to claim 1, wherein the information includes a current date and time.

4. The gaming machine according to claim 1, wherein the information includes a predetermined whole payout ratio and a current date and time.

5. The gaming machine according to claim 1, wherein the information includes a playing time.

6. The gaming machine according to claim 1, wherein the information includes the number of executed games since a predetermined combination appeared.

7. The gaming machine according to claim 1, wherein the information includes a predetermined whole payout ratio and the number of executed games since a predetermined combination appeared.

8. The gaming machine according to claim 1, wherein the information includes the number of input gaming medium's value.

9. The gaming machine according to claim 1, wherein the information includes a different value according to a bet gaming medium's value and an output gaming medium's value.

10. A gaming machine comprising:
a display configured to display plural symbols; and
a processor programmed to:
execute a unit game based on a first payout ratio, the unit game including that the symbols are started to variably displayed and then the symbols are stopped and displayed,
count the number of executed the unit games with the first payout ratio,
change the first payout ratio for a second payout ratio in response to the number of executed the unit games with the first payout ratio becoming a first predetermined number of times, the second payout ratio differing from the first payout ratio, and the first predetermined number of times corresponding to the first payout ratio, and
execute the unit game based on the second payout ratio.

11. The gaming machine according to claim 10, wherein the processor is programmed to execute the unit game based on the second payout ratio a second predetermined number of times, the second predetermined number of times corresponding to the second payout ratio.

12. The gaming machine according to claim 11, wherein (a) the first predetermined number of times is determined based on a predetermined payout ratio, the first payout ratio, and the second payout ratio, and (b) the second predetermined number of times is determined based on the predetermined payout ratio, the first payout ratio, and the second payout ratio.

13. The gaming machine according to claim 12, wherein the predetermined payout ratio differs from the first payout ratio and the second payout ratio.

14. The gaming machine according to claim 11, wherein the processor is programmed to:
count the number of executed the unit games with the second payout ratio,
change the second payout ratio for a third payout ratio in response to the number of executed the unit game with the second payout ratio becoming the second predetermined number of times, the third payout ratio differing from the second payout ratio, and
execute the unit game based on the third payout ratio.

15. The gaming machine according to claim 11, wherein the processor is programmed to:
count the number of executed the unit games with the second payout ratio,
change the second payout ratio for a third payout ratio in response to the number of executed the unit game with the second payout ratio becoming the second predetermined number of times, the third payout ratio differing from the first payout ratio and the second payout ratio, and
execute the unit game based on the third payout ratio.

16. The gamin machine according to claim 15, wherein the processor is programmed to execute the unit game based on the third payout ratio a third predetermined number of times, the third predetermined number of times corresponding to the third payout ratio.

17. The gaming machine according to claim 16, wherein (a) the first predetermined number of times is determined based on the predetermined payout, the first payout ratio, the second payout ratio, and the third payout ratio, (b) the second predetermined number of times is determined based on the predetermined payout ratio, the first payout ratio, the second payout ratio, and the third payout ratio, and (c) the third predetermined number of times is determined based on the predetermined payout ratio, the first payout ratio, the second payout ratio, and the third payout ratio.

18. The gaming machine according to claim 17, wherein the predetermined payout ratio differs from the first payout ratio, the second payout ratio, and the third payout ratio.

19. The gaming machine according to claim 16, wherein the processor is programmed to:
count the number of executed the unit games with the third payout ratio, and
change the third payout ratio for the first payout ratio in response to the number of executed the unit game with the third payout ratio becoming the third predetermined number of times.
